(19) United States
(12) Patent Application Publication
(10) Pub. No.: US 2025/0306312 A1
(43) Pub. Date: Oct. 2, 2025

(54) PHOTONIC INTEGRATED CIRCUIT PACKAGES INCLUDING A BARRIER MATERIAL TO CONFINE A THERMAL INTERFACE MATERIAL

(71) Applicant: Intel Corporation, Santa Clara, CA (US)

(72) Inventors: Wei Gong, Mesa, AZ (US); Paulo Costa, Mesa, AZ (US); Sergio Antonio Chan Arguedas, Chandler, AZ (US); Ziyin Lin, Chandler, AZ (US); Kumar Abhishek Singh, Phoenix, AZ (US)

(73) Assignee: Intel Corporation, Santa Clara, CA (US)

(21) Appl. No.: 18/616,365

(22) Filed: Mar. 26, 2024

(51) Int. Cl. G02B 6/42

(52) U.S. Cl. CPC G02B 6/4267; G02B 6/423; G02B 6/4269; G02B 6/428

(57) ABSTRACT

Microelectronic assemblies, related devices and methods, are disclosed herein. In some embodiments, a microelectronic assembly may include a substrate having a surface with an edge; a photonic integrated circuit (PIC), having a first surface and an opposing second surface, including a first portion within a footprint of the substrate and a second portion that extends beyond the edge of the substrate; a heat transfer structure; a first material on the second surface of the second portion of the PIC adjacent to the edge of the substrate, wherein the first material includes a low modulus, elastic polymer composite, an adhesive tape, or a foam tape; and a second material including a thermal interface material (TIM) between the second surface of the second portion of the PIC and the heat transfer structure, wherein the first material is between the second material and the edge of the substrate.

### BACKGROUND

The present disclosure relates to integrated circuits (ICs) including components for optical communications, such as photonic integrated circuits (PICs). More specifically, it relates to techniques, methods, and apparatus directed to PIC packaging architecture.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1A is a schematic cross-sectional view of an example microelectronic assembly according to some embodiments of the present disclosure.

FIG. 1B is a schematic illustration of an example detail of an active surface of a photonic integrated circuit according to some embodiments of the present disclosure.

FIG. 2A is a schematic cross-sectional view of another example microelectronic assembly according to some embodiments of the present disclosure.

FIG. 2B is a schematic cross-sectional view of a portion of the example microelectronic assembly of FIG. 2A.

FIG. 3 is a schematic top view of a portion of the example microelectronic assembly of FIG. 1A according to some embodiments of the present disclosure.

FIG. 4 is a schematic top view of a portion of the example microelectronic assembly of FIG. 2A according to some embodiments of the present disclosure.

FIG. 5 is a schematic top view of a portion of another example microelectronic assembly according to some embodiments of the present disclosure.

FIGS. 6A-6E are simplified top views illustrating various manufacturing steps of the example microelectronic assembly of FIG. 1A according to some embodiments of the present disclosure.

FIGS. 7A-7E are simplified top views illustrating various manufacturing steps of the example microelectronic assembly of FIG. 2A according to some embodiments of the present disclosure.

FIG. 8 is a cross-sectional view of a device package that includes one or more microelectronic assemblies in accordance with any of the embodiments disclosed herein.

FIG. 9 is a cross-sectional side view of a device assembly that includes one or more microelectronic assemblies in accordance with any of the embodiments disclosed herein.

FIG. 10 is a block diagram of an example computing device that includes one or more microelectronic assemblies in accordance with any of the embodiments disclosed herein.

### DETAILED DESCRIPTION

For purposes of illustrating photonic IC packages described herein, it is important to understand phenomena that may come into play during assembly and packaging of PICs. The following foundational information may be viewed as a basis from which the present disclosure may be properly explained. Such information is offered for purposes of explanation only and, accordingly, should not be construed in any way to limit the broad scope of the present disclosure and its potential applications. Advances in semiconductor processing and logic design have permitted an increase in the amount of logic circuits that may be included in processors and other IC devices. Current technologies permit hundreds and thousands of such active circuit elements to be formed on a single die so that numerous logic circuits may be enabled thereon. Similarly, off-package input/output (I/O) bandwidth has been steadily doubling every couple of years. IC packaging and I/O technologies continuously scale to meet the increased bandwidth demand. As a result, package pin counts and I/O data rates continue to increase. However, electrical I/O reach (e.g., length of electrical trace) continues to reduce at increased data rates. One solution to overcome these limitations is to implement optical transmission of signals.

Integrating optical communications to IC packages further increases the complexity. Contemporary optical communications and other systems often employ PICs. Smaller, faster, and less expensive optical elements can enable universal, low-cost, high-volume optical communications needed for fast and efficient communication technologies demanded by high volume internet data traffic. In optical communications, information is transmitted by way of an optical carrier whose frequency typically is in the visible or near-infrared region of the electromagnetic spectrum. A carrier with such a high frequency is sometimes referred to as an optical signal, an optical carrier, a light wave signal, or simply light. A typical optical communications network includes several optical fibers, each of which may include several channels. A channel is a specified frequency band of an electromagnetic signal and is sometimes referred to as a wavelength. Technological advances today enable implementing portions of optical communication systems at the IC (or chip or die) level in PICs.

In a general sense, a PIC integrates photonic functions for information signals imposed on electromagnetic waves, e.g., electromagnetic waves of optical wavelengths. PICs find application in fiber-optic communication, medical, security, sensing, and photonic computing systems. The PIC may implement one or more optical and electro-optical devices such as lasers, photodetectors, waveguides, and modulators on a single semiconductor chip. In addition, the PIC may also include electrical circuitry to process electrical signals corresponding to these optical signals. Such integrated PICs have both photonic processing and electrical signal processing in a same process node which may limit optimization. In other embodiments, PIC may be in a separate process node that optimizes PIC performance and electrical signal processing may be in a different process node that optimizes the electrical high-speed performance. Typically, IC packages include tight-pitch interconnects that enable high density, high bandwidth electrical communication between the PIC and other electrical devices, such as processor integrated circuits (XPU), also referred to herein as “processor IC,” and electrical integrated circuits (EIC) with simultaneous optical access to the PIC for the optical signals.

Maintaining an optical signal between a PIC and an external source (e.g., a fiber) can be difficult. Indeed, getting optical signals into and out of PICs is a driver of manufacturing cost and complexity. One way to couple a PIC to a fiber is to implement edge-coupling by using an optical coupling structure (OCS) (sometimes referred to as “fiber connector,” “fiber assembly unit” (FAU), or “fiber array block”) that has one end coupled to a fiber and an opposite end placed proximate to a PIC so that optical signals may be exchanged between the PIC and the fiber, via the OCS. Because the signals require a transparent medium for propagation, an optical surface of the PIC is exposed in the package to allow the fiber to be optically coupled to the PIC. For example, in some packaging architectures, the PIC has a V-groove channel that overhangs the package substrate (e.g., substrate has a cut-out under the V-groove channel of the PIC) and a fiber is positioned into the V-groove channel that aligns to an optical waveguide of a PIC and securing the fiber in the V-groove with a resin or an adhesive that surrounds the fiber.

Packaging such PICs presents many challenges. Among the challenges is using a thermal interface material (TIM) as a thermal solution, in particular, using a polymer-based thermal interface material (PTIM), liquid-metal-based thermal interface material (YTIM), and/or a vertical graphical carbon-based thermal interface material (VCTIM). In a standard direct lid attach (DLA) process, the PTIM/YTIM may spread freely without constraint on a die surface area. The PTIM/YTIM may spread to the exposed optical surface of the PIC (e.g., a bottom surface of the PIC) and contaminate the V-groove channel, which may cause an optical signal to fail. If the amount of PTIM/YTIM deposited on the die surface area is reduced to prevent spread and contamination, the PIC may not have sufficient coverage and may cause problems for thermal dissipation. If an optical signal fails due to a TIM contamination, the IC package must be discarded, which severely impacts manufacturing by decreasing yields and increasing costs. Structures and methods that enable using a TIM as a thermal solution without contamination of the PIC optical surface may be desired.

In one aspect of the present invention, a barrier material may be on a PIC adjacent to an edge of the package substrate to constrain the PTIM/YTIM during the DLA process and to prevent the PTIM/YTIM from spreading and contaminating the V-groove area. A barrier material may include a compressible material and/or a material that is compressible after a partial curing process, such that the barrier material may be compressed to a desired final thickness without introducing high stress on the PIC.

Accordingly, microelectronic assemblies, related devices and methods, are disclosed herein. In some embodiments, a microelectronic assembly may include a substrate having a surface with an edge, wherein the substrate includes a dielectric material with conductive pathways; a PIC having a first surface and an opposing second surface, and including a first portion within a footprint of the substrate and a second portion that extends beyond the edge of the substrate, wherein the first surface of the first portion of the PIC is electrically coupled to one or more of the conductive pathways in the substrate; a heat transfer structure at the second surface of the PIC; a first material on the second surface of the second portion of the PIC adjacent to the edge of the substrate, wherein the first material includes a low modulus, elastic polymer composite, an adhesive tape or a foam tape; and a second material on the second surface of the second portion of the PIC, wherein the second material includes a thermal interface material (TIM), wherein the first material is between the second material and the edge of the substrate, and wherein the first material and the second material are between the PIC and the heat transfer structure.

An example photonic IC package architecture disclosed herein may further include coupling a plurality of PICs, EICs, XPUs, and/or interconnect dies using high-density interconnects. As used herein, “high-density interconnects” include interconnects having a pitch of less than 10 microns. As used herein, pitch is measured center-to-center (e.g., from a center of an interconnect to a center of an adjacent interconnect). The terms “interconnect die,” “bridge die,” “bridge,” “interconnect bridge” may be used interchangeably herein.

Each of the structures, assemblies, packages, methods, devices, and systems of the present disclosure may have several innovative aspects, no single one of which is solely responsible for all the desirable attributes disclosed herein. Details of one or more implementations of the subject matter described in this specification are set forth in the description below and the accompanying drawings.

In the following detailed description, various aspects of the illustrative implementations may be described using terms commonly employed by those skilled in the art to convey the substance of their work to others skilled in the art.

The terms “circuit” and “circuitry” mean one or more passive and/or active electrical and/or electronic components that are arranged to cooperate with one another to provide a desired function.

The terms also refer to analog circuitry, digital circuitry, hard wired circuitry, programmable circuitry, microcontroller circuitry and/or any other type of physical hardware electrical and/or electronic component.

The term “integrated circuit” means a circuit that is integrated into a monolithic semiconductor or analogous material.

In some embodiments, the IC dies disclosed herein may comprise substantially monocrystalline semiconductors, such as silicon or germanium, as a base material (e.g., substrate, body) on which integrated circuits are fabricated with traditional semiconductor processing methods. The semiconductor base material may include, for example, N-type or P-type materials. Dies may include, for example, a crystalline base material formed using a bulk silicon (or other bulk semiconductor material) or a silicon-on-insulator (SOI) structure. In some other embodiments, the base material of one or more of the IC dies may comprise alternate materials, which may or may not be combined with silicon, that include but are not limited to germanium, indium antimonide, lead telluride, indium arsenide, indium phosphide, gallium arsenide, indium gallium arsenide, gallium antimonide, or other combinations of group III-N, group III-V, group II-VI, or group IV materials. In yet other embodiments, the base material may comprise compound semiconductors, for example, with a first sub-lattice of at least one element from group III of the periodic table (e.g., Al, Ga, In), and a second sub-lattice of at least one element of group V of the periodic table (e.g., P, As, Sb). In yet other embodiments, the base material may comprise an intrinsic IV or III-V semiconductor material or alloy, not intentionally doped with any electrically active impurity; in alternate embodiments, nominal impurity dopant levels may be present. In still other embodiments, dies may comprise a non-crystalline material, such as polymers; for example, the base material may comprise silica-filled epoxy. In other embodiments, the base material may comprise high mobility oxide semiconductor material, such as tin oxide, antimony oxide, indium oxide, indium tin oxide, titanium oxide, zinc oxide, indium zinc oxide, indium gallium zinc oxide (IGZO), gallium oxide, titanium oxynitride, ruthenium oxide, or tungsten oxide. In general, the base material may include one or more of tin oxide, cobalt oxide, copper oxide, antimony oxide, ruthenium oxide, tungsten oxide, zinc oxide, gallium oxide, titanium oxide, indium oxide, titanium oxynitride, indium tin oxide, indium zinc oxide, nickel oxide, niobium oxide, copper peroxide, IGZO, indium telluride, molybdenite, molybdenum diselenide, tungsten diselenide, tungsten disulfide, N- or P-type amorphous or polycrystalline silicon, germanium, indium gallium arsenide, silicon germanium, gallium nitride, aluminum gallium nitride, indium phosphide, and black phosphorus, each of which may possibly be doped with one or more of gallium, indium, aluminum, fluorine, boron, phosphorus, arsenic, nitrogen, tantalum, tungsten, and magnesium, etc. Although a few examples of the material for dies are described here, any material or structure that may serve as a foundation (e.g., base material) upon which IC circuits and structures as described herein may be built falls within the spirit and scope of the present disclosure.

Unless described otherwise, IC dies described herein include one or more IC structures (or, simply, “ICs”) implementing (i.e., configured to perform) certain functionality. In one such example, the term “memory die” may be used to describe a die that includes one or more ICs implementing memory circuitry (e.g., ICs implementing one or more of memory devices, memory arrays, control logic configured to control the memory devices and arrays, etc.). In another such example, the term “compute die” may be used to describe a die that includes one or more ICs implementing logic/compute circuitry (e.g., ICs implementing one or more of I/O functions, arithmetic operations, pipelining of data, etc.).

In another example, the terms “package” and “IC package” are synonymous, as are the terms “die” and “IC die.” Note that the terms “chip,” “chiplet,” “die,” and “IC die” are used interchangeably herein.

The term “insulating” means “electrically insulating,” the term “conducting” means “electrically conducting,” unless otherwise specified. With reference to optical signals and/or devices, components and elements that operate on or using optical signals, the term “conducting” can also mean “optically conducting.”

The terms “oxide,” “carbide,” “nitride,” etc. refer to compounds containing, respectively, oxygen, carbon, nitrogen, etc.

The term “high-k dielectric” refers to a material having a higher dielectric constant than silicon oxide, while the term “low-k dielectric” refers to a material having a lower dielectric constant than silicon oxide.

The term “insulating material” or “insulator” (also called herein as “dielectric material” or “dielectric”) refers to solid materials (and/or liquid materials that solidify after processing as described herein) that are substantially electrically nonconducting. They may include, as examples and not as limitations, organic polymers and plastics, and inorganic materials such as ionic crystals, porcelain, glass, silicon, silicon oxide, silicon carbide, silicon carbonitride, silicon nitride, and alumina or a combination thereof. They may include dielectric materials, high polarizability materials, and/or piezoelectric materials. A dielectric material may include any suitable dielectric material commonly used in semiconductor manufacture, such as silicon and one or more of oxygen, nitrogen, hydrogen, and carbon (e.g., in the form of silicon oxide, silicon nitride, silicon oxynitride, or silicon carbon nitride); a polyimide material; or a low-k or ultra low-k dielectric (e.g., carbon-doped dielectrics, fluorine-doped dielectrics, porous dielectrics, organic polymeric dielectrics, photo-imageable dielectrics, and/or benzocyclobutene-based polymers). They may be transparent or opaque without departing from the scope of the present disclosure. Further examples of insulating materials are underfills and molds or mold-like materials used in packaging applications, including for example, materials used in organic interposers, package supports and other such components.

In various embodiments, elements associated with an IC may include, for example, transistors, diodes, power sources, resistors, capacitors, inductors, sensors, transceivers, receivers, antennas, etc. In various embodiments, elements associated with an IC may include those that are monolithically integrated within an IC, mounted on an IC, or those connected to an IC. The ICs described herein may be either analog or digital and may be used in a number of applications, such as microprocessors, optoelectronics, logic blocks, audio amplifiers, etc., depending on the components associated with the IC. The ICs described herein may be employed in a single IC die or as part of a chipset for executing one or more related functions in a computer.

In various embodiments of the present disclosure, transistors described herein may be field-effect transistors (FETs), e.g., MOSFETs. In many embodiments, an FET is a four-terminal device. In silicon-on-insulator, or nanoribbon, or gate all-around (GAA) FET, the FET is a three-terminal device that includes source, drain, and gate terminals and uses electric field to control current flowing through the device. A FET typically includes a channel material, a source region and a drain regions provided in and/or over the channel material, and a gate stack that includes a gate electrode material, alternatively referred to as a “work function” material, provided over a portion of the channel material (the “channel portion”) between the source and the drain regions, and optionally, also includes a gate dielectric material between the gate electrode material and the channel material.

In a general sense, an “interconnect” refers to any element that provides a physical connection between two other elements. For example, an electrical interconnect provides electrical connectivity between two electrical components, facilitating communication of electrical signals between them; an optical interconnect provides optical connectivity between two optical components, facilitating communication of optical signals between them. As used herein, both electrical interconnects and optical interconnects are comprised in the term “interconnect.” The nature of the interconnect being described is to be understood herein with reference to the signal medium associated therewith. Thus, when used with reference to an electronic device, such as an IC that operates using electrical signals, the term “interconnect” describes any element formed of an electrically conductive material for providing electrical connectivity to one or more elements associated with the IC or/and between various such elements. In such cases, the term “interconnect” may refer to both conductive traces (also sometimes referred to as “lines,” “wires,” “metal lines” or “trenches”) and conductive vias (also sometimes referred to as “vias” or “metal vias”). Sometimes, electrically conductive traces and vias may be referred to as “conductive traces” and “conductive vias”, respectively, to highlight the fact that these elements include electrically conductive materials such as metals. Likewise, when used with reference to a device that operates on optical signals as well, such as a PIC, “interconnect” may also describe any element formed of a material that is optically conductive for providing optical connectivity to one or more elements associated with the PIC. In such cases, the term “interconnect” may refer to optical waveguides, including optical fiber, optical splitters, optical combiners, optical couplers, and optical vias.

As used herein, the term “optical element” includes arrangements of forms fabricated in ICs to receive, transform and/or transmit optical signals as described herein. It may include optical conductors such as waveguides, grating coupler, electromagnetic radiation sources such as lasers, and electro-optical devices such as photodetectors.

The term “waveguide” refers to any structure that acts to guide the propagation of light from one location to another location typically through a substrate material such as silicon or glass. In various examples, waveguides can be formed from silicon, doped silicon, silicon nitride, glasses such as silica (e.g., silicon dioxide or SiO₂), borosilicate (e.g., 70-80 wt % SiO₂, 7-13 wt % of B₂O₃, 4-8 wt % Na₂O or K₂O, and 2-8 wt % of Al₂O₃) and so forth. Waveguides may be formed using various techniques including but not limited to forming waveguides in situ. For example, in some embodiments, waveguides may be formed in situ in glass using low temperature glass-to-glass bonding or by laser direct writing (e.g., a laser written waveguide). Waveguides formed in situ may have lower loss characteristics.

The term “conductive trace” may be used to describe an electrically conductive element isolated by an insulating material. Within IC dies, such insulating material comprises interlayer low-k dielectric that is provided within the IC die. Within package substrates, and printed circuit boards (PCBs) such insulating material comprises organic materials such as Ajinomoto Buildup Film (ABF), polyimides, or epoxy resin. Such conductive lines are typically arranged in several levels, or several layers, of metallization stacks.

The term “conductive via” may be used to describe an electrically conductive element that interconnects two or more conductive lines of different levels of a metallization stack. To that end, a via may be provided substantially perpendicularly to the plane of an IC die/chip or a support structure over which an IC structure is provided and may interconnect two conductive lines in adjacent levels or two conductive lines in non-adjacent levels.

The term “package substrate” may be used to describe any substrate material that facilitates the packaging together of any collection of semiconductor dies and/or other electrical components such as passive electrical components. As used herein, a package substrate may be formed of any material including, but not limited to, insulating materials such as resin impregnated glass fibers (e.g., PCB or Printed Wiring Boards (PWB)), glass, ceramic, silicon, silicon carbide, etc. In addition, as used herein, a package substrate may refer to a substrate that includes buildup layers (e.g., ABF layers).

The term “metallization stack” may be used to refer to a stack of one or more interconnects for providing connectivity to different circuit components of an IC die/chip and/or a package substrate.

As used herein, the term “pitch” of interconnects refers to a center-to-center distance between adjacent interconnects.

The terms “substantially,” “close,” “approximately,” “near,” and “about,” generally refer to being within +/−20% of a target value (e.g., within +/−5% or 10% of a target value) based on the context of a particular value as described herein or as known in the art.

Terms indicating orientation of various elements, e.g., “coplanar,” “perpendicular,” “orthogonal,” “parallel,” or any other angle between the elements, generally refer to being within +/−5%-20% of a target value based on the context of a particular value as described herein or as known in the art.

The term “connected” means a direct connection (which may be one or more of a mechanical, electrical, and/or thermal connection) between the things that are connected, without any intermediary devices, while the term “coupled” means either a direct connection between the things that are connected, or an indirect connection through one or more passive or active intermediary devices.

The description uses the phrases “in an embodiment” or “in embodiments,” which may each refer to one or more of the same or different embodiments.

Furthermore, the terms “comprising,” “including,” “having,” and the like, as used with respect to embodiments of the present disclosure, are synonymous.

The disclosure may use perspective-based descriptions such as “above,” “below,” “top,” “bottom,” and “side”; such descriptions are used to facilitate the discussion and are not intended to restrict the application of disclosed embodiments.

The terms “over,” “under,” “between,” and “on” as used herein refer to a relative position of one material layer or component with respect to other layers or components. For example, one layer disposed over or under another layer may be directly in contact with the other layer or may have one or more intervening layers. Moreover, one layer disposed between two layers may be directly in contact with one or both of the two layers or may have one or more intervening layers. In contrast, a first layer described to be “on” a second layer refers to a layer that is in direct contact with that second layer. Similarly, unless explicitly stated otherwise, one feature disposed between two features may be in direct contact with the adjacent features or may have one or more intervening layers.

The term “dispose” as used herein refers to position, location, placement, and/or arrangement rather than to any particular method of formation.

The term “between,” when used with reference to measurement ranges, is inclusive of the ends of the measurement ranges.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). When used herein, the notation “A/B/C” means (A), (B), and/or (C).

Although certain elements may be referred to in the singular herein, such elements may include multiple sub-elements. For example, “an electrically conductive material” may include one or more electrically conductive materials. In another example, “a dielectric material” may include one or more dielectric materials.

Unless otherwise specified, the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

In the following detailed description, reference is made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

The accompanying drawings are not necessarily drawn to scale.

Coordinates, when included in the accompanying drawings, identify a thickness or a height by z-dimension, a width by y-dimension, and a length by x-dimension. A diameter or cross section may be identified by xy-dimension.

In the drawings, same reference numerals refer to the same or analogous elements/materials shown so that, unless stated otherwise, explanations of an element/material with a given reference numeral provided in context of one of the drawings are applicable to other drawings where element/materials with the same reference numerals may be illustrated. Further, the singular and plural forms of the labels may be used with reference numerals to denote a single one and multiple ones respectively of the same or analogous type, species, or class of element.

Furthermore, in the drawings, some schematic illustrations of example structures of various devices and assemblies described herein may be shown with precise right angles and straight lines, but it is to be understood that such schematic illustrations may not reflect real-life process limitations which may cause the features to not look so “ideal” when any of the structures described herein are examined using, e.g., images of suitable characterization tools such as scanning electron microscopy (SEM) images, transmission electron microscope (TEM) images, or non-contact profilometer. In such images of real structures, possible processing and/or surface defects could also be visible, e.g., surface roughness, curvature or profile deviation, pit or scratches, not-perfectly straight edges of materials, tapered vias or other openings, inadvertent rounding of corners or variations in thicknesses of different material layers, occasional screw, edge, or combination dislocations within the crystalline region(s), and/or occasional dislocation defects of single atoms or clusters of atoms. There may be other defects not listed here but that are common within the field of device fabrication and/or packaging.

Note that in the figures, various components (e.g., interconnects) are shown as aligned (e.g., at respective interfaces) merely for ease of illustration; in actuality, some or all of them may be misaligned. In addition, there may be other components, such as bond-pads, landing pads, metallization, etc. present in the assembly that are not shown in the figures to prevent cluttering. Further, the figures are intended to show relative arrangements of the components within their assemblies, and, in general, such assemblies may include other components that are not illustrated (e.g., various interfacial layers or various other components related to optical functionality, electrical connectivity, or thermal mitigation). For example, in some further embodiments, the assembly as shown in the figures may include more dies along with other electrical components. Additionally, although some components of the assemblies are illustrated in the figures as being planar rectangles or formed of rectangular solids, this is simply for ease of illustration, and embodiments of these assemblies may be curved, rounded, or otherwise irregularly shaped as dictated by and sometimes inevitable due to the manufacturing processes used to fabricate various components.

In the drawings, a particular number and arrangement of structures and components are presented for illustrative purposes and any desired number or arrangement of such structures and components may be present in various embodiments.

Further, unless otherwise specified, the structures shown in the figures may take any suitable form or shape according to material properties, fabrication processes, and operating conditions.

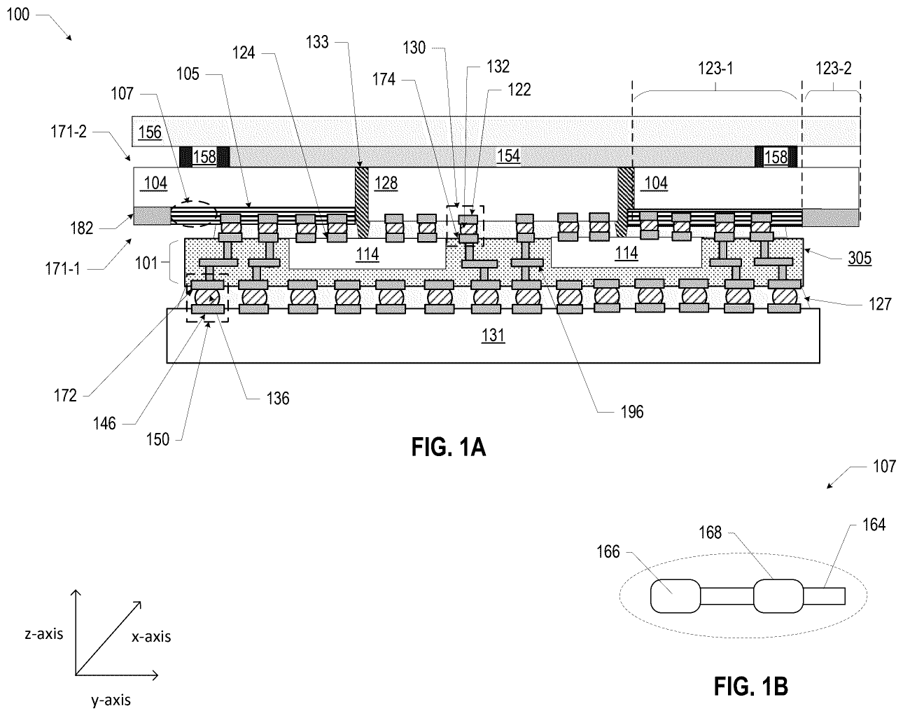

For convenience, if a collection of drawings designated with different letters are present (e.g., FIGS. 1A and 1B), such a collection may be referred to herein without the letters (e.g., as “FIG. 1”). Similarly, if a collection of reference numerals designated with different numerals or letters are present (e.g., 114-1, 114-2), such a collection may be referred to herein without the numerals or letters (e.g., as “114”).

Various operations may be described as multiple discrete actions or operations in turn in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed, and/or described operations may be omitted in additional embodiments.

### Example Embodiments

FIG. 1A is a schematic cross-sectional view of an example microelectronic assembly 100 according to some embodiments of the present disclosure. Microelectronic assembly 100 comprises a substrate 101 and a PIC 104 having a first surface 171-1 and an opposing second surface 172-2, where the first surface 171-1 includes a fiber alignment region 182 (e.g., a recessed channel with a V-shape or other similar shape) forming an optical pathway between PIC 104 and an external optical source (not shown). As used herein, the terms “microelectronic assembly,” “photonic package,” “photonic microelectronic assembly,” and similar variations may be used interchangeably. As used herein, the term “optical pathway” refers to a path or trajectory by which light propagates from one location to another location through an optical medium. In some embodiments, an optical pathway may include one or more waveguides or other structures that guide the path of light or may include a passthrough structure. In some embodiments, the optical pathway may include a reflector or other component configured to transmit a signal from a vertical direction to a lateral direction or from a lateral direction to a vertical direction.

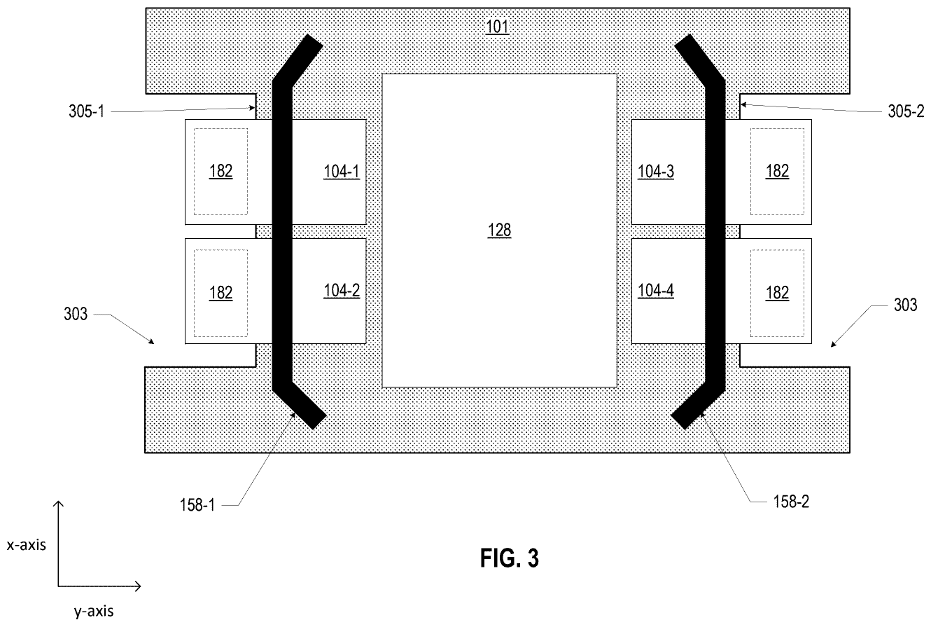

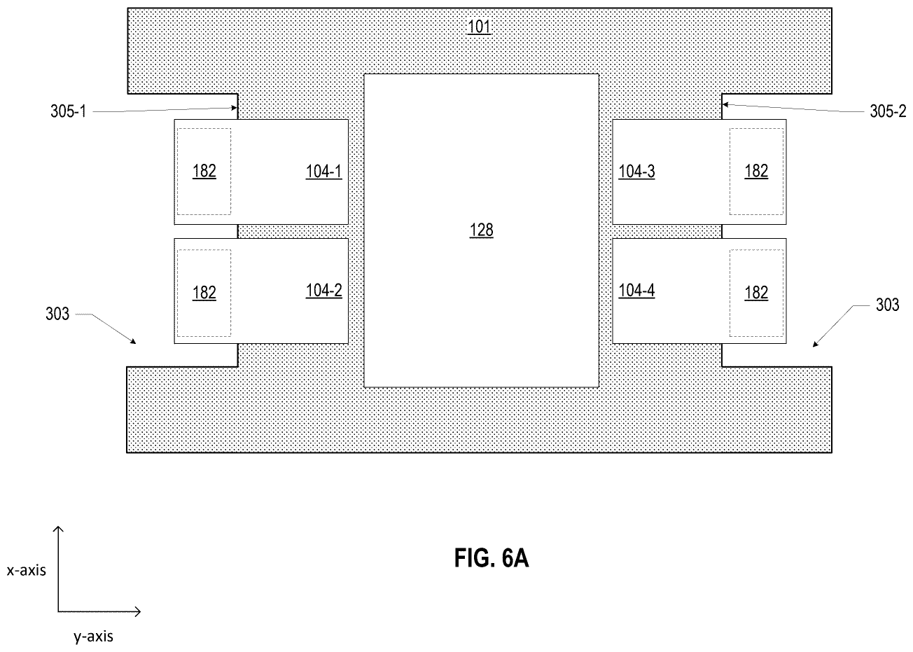

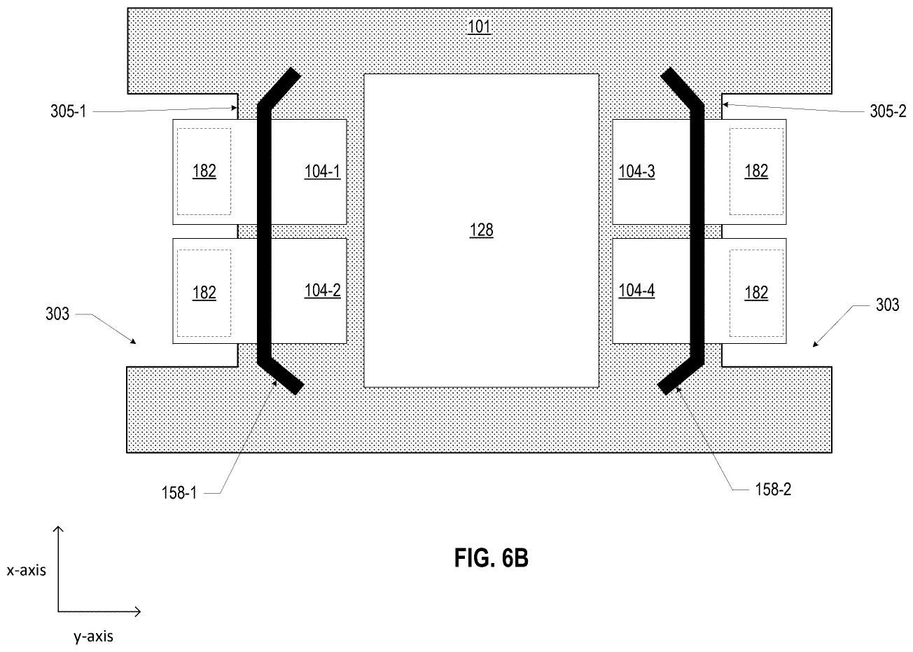

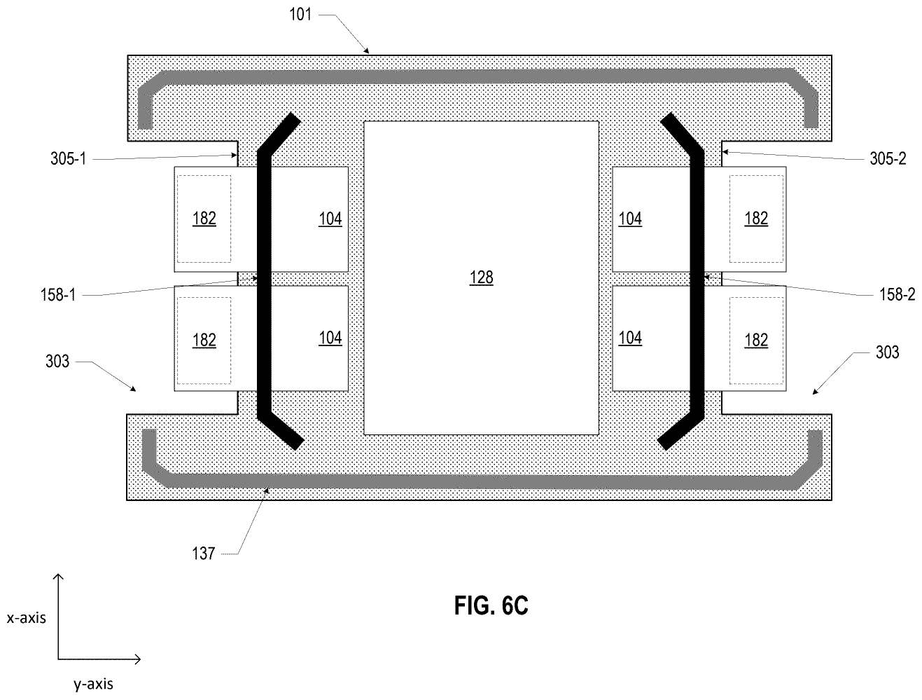

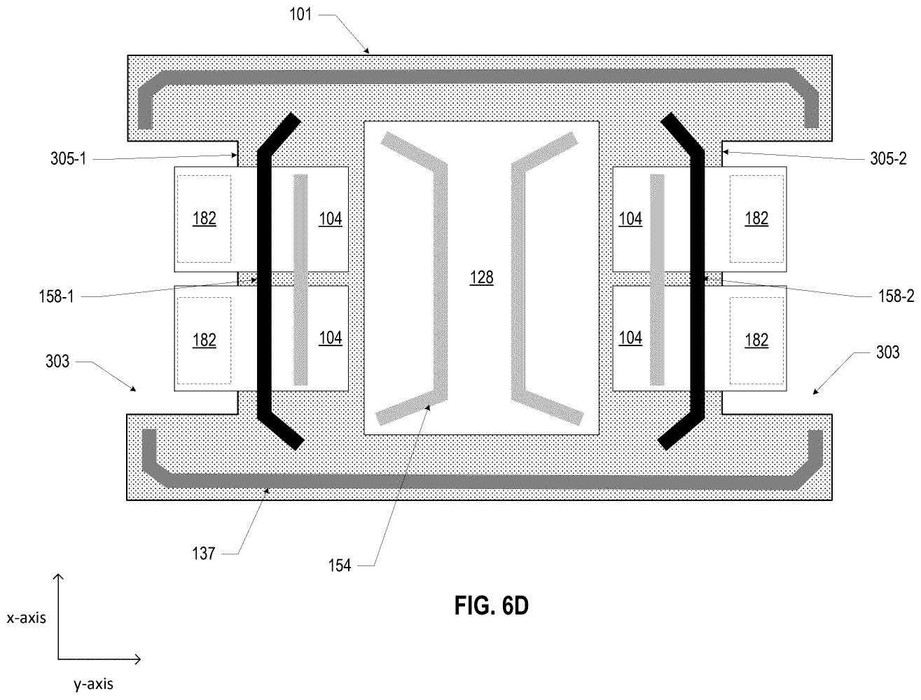

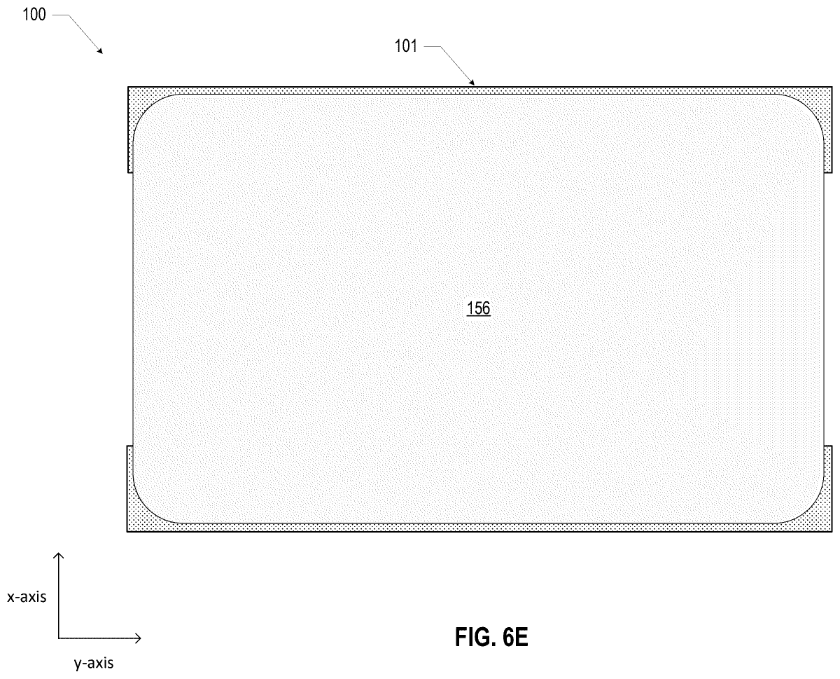

In particular, the PIC 104 includes a first portion 123-1 within a footprint of the substrate 101 and a second portion 123-2 that extends beyond (e.g., overhangs) an edge 305 of the substrate 101. The first portion 123-1 of the first surface 171-1 of the PIC 104 is electrically coupled to the substrate 101 by interconnects 130, and the second portion 123-2 of the first surface 171-1 of the PIC 104 includes the fiber alignment region 182 that is exposed for forming an optical pathway. The first portion 123-1 of the second surface 171-2 of the PIC 104 may include a barrier material 158 adjacent to an edge 305 of the substrate 101. The barrier material 158 may include a low modulus, elastic polymer composite, such as silicone or other rubber. The barrier material 158 may further include a filler, such as aluminum and oxygen (e.g., in the form of aluminum oxide), zinc and oxygen (e.g., in the form of zinc oxide), or silicon and oxygen (e.g., in the form of silicon oxide), or an additive, for achieving desired properties related to rheology, curing, and adhesion. A barrier material 158 may have any suitable dimensions. In some embodiments, a barrier material 158 may have a width (e.g., y-dimension) between 200 microns and 500 microns, and a thickness (e.g., z-dimension) between 30 microns and 50 microns (e.g., between the top surface 171-2 of the PIC 104 and a bottom surface of the heat transfer structure 156). A barrier material 158 may have any suitable length (e.g., x-dimension) and may extend beyond a length of a PIC 104, as shown in FIGS. 3-5. As described below with reference to FIG. 6, a barrier material 158 may be attached to PIC 104 during assembly of the microelectronic assembly 100.

The photonic microelectronic assembly 100 of FIG. 1A may also include a TIM 154. The TIM 154 may include a PTIM, a YTIM, and/or a VCTIM. In some embodiments, the TIM 154 may include a thermally conductive material (e.g., metal particles) in a polymer or other binder, such as a solder and gallium-based material. In some embodiments, the TIM 154 may include a thermal interface material paste or a thermally conductive epoxy (which may be a fluid when applied and may harden upon curing, as known in the art). In some embodiments, the TIM 154 may include a polymeric composite, such as a polymeric resin (e.g., silicone) with thermal conductivity fillers (e.g., aluminum, aluminum oxide, or other liquid metal). In some embodiments, the TIM 154 may be carbon-based (e.g., including aligned graphite, graphene, carbon nanotubes, or carbon fiber). The TIM 154 may provide a path for heat generated by the dies (e.g., one or more of EIC 114, XPU 128, and PIC 104) to readily flow to a heat transfer structure 156, where it may be spread and/or dissipated. The TIM 154 may be contained by the barrier material 158. Some embodiments of the photonic microelectronic assembly 100 of FIG. 1A may include a sputtered metallization (not shown) across the top surface of the XPU 128 and PIC 104; the TIM 154 (e.g., a solder TIM) may be disposed on this metallization.

The photonic microelectronic assembly 100 of FIG. 1A may also include a heat transfer structure 156. The heat transfer structure 156 may be used to move heat away from one or more of the dies (e.g., one or more of EIC 114, XPU 128, and PIC 104), so that the heat may be more readily dissipated. The heat transfer structure 156 may include any suitable thermally conductive material (e.g., metal, appropriate ceramics, etc.), and may include any suitable features (e.g., a heat spreader, a heat sink including fins, a cold plate, etc.). In some embodiments, a heat transfer structure 156 may be or may include an integrated heat spreader (IHS).

PIC 104 may include a first surface 171-1 (e.g., a bottom surface) and an opposing second surface 171-2 (e.g., a top surface), where the first surface 171-1 is also an active surface 105. A first portion of active surface 105 of PIC 104 may include fiber alignment region 182 and a second portion of active surface 105 may include conductive contacts 122 on a bottom surface of PIC 104. The conductive contacts 122 may be electrically and mechanically coupled to conductive contacts 174 on the top surface of a substrate 101 and to conductive contacts 124 on a top surface of EIC 114 by interconnects 130. A first portion of active surface 105 of the PIC 104 may include optical elements. Example optical elements over the first portion of active surface 105 are shown in more detail in FIG. 1B and described below.

FIG. 1B is a schematic of a face of active surface 105 (e.g., looking at the active surface 105 of the PIC 104). Example optical elements include an electromagnetic radiation source 166, an electro-optical device 168, and a waveguide 164. In many embodiments, the optical elements may be fabricated on active surface 105 using any known method in the art, including semiconductor photolithographic and deposition methods. In some embodiments, the optical elements may extend substantially across an entire area of active surface 105 (not shown). In some embodiments, the optical elements may be confined within a portion of active surface 105. In some embodiments, a PIC 104 may be configured to transmit and/or receive an optical signal at a lateral surface, as shown in FIG. 1A. In such examples, PIC 104 may include optical elements, such as an edge coupler, a V-groove array, or an angled reflector with a grating coupler, at an active surface 105 that allow PIC 104 to transmit and/or receive light through a lateral surface that is substantially perpendicular to the active surface 105 (e.g., lateral transmission and reception of light). In some embodiments, a PIC 104 may be configured to transmit and/or receive an optical signal at an active surface 105. For example, PIC 104 may include optical elements, such as a grating coupler, at an active surface 105 that allow PIC 104 to transmit and/or receive light through the active surface 105 (e.g., vertical transmission and reception of light).

Electromagnetic radiation source 166 can enable generating optical signals and may include lasers, for example if PIC 104 supports wavelengths between about 0.8 and 1.7 micrometer. Electro-optical device 168 can enable receiving, transforming, and transmitting optical signals. In some embodiments, electro-optical device 168 may be any device or component configured to encode information in/onto the electromagnetic signals, such as modulator, polarizer, phase shifter, and photodetector.

Waveguide 164 can guide optical signals and also perform coupling, switching, splitting, multiplexing and demultiplexing optical signals. In some embodiments, waveguide 164 may include any component configured to feed, or launch, the electromagnetic signal into the medium of propagation such as an optical fiber. In some embodiments, waveguide 164 may further be configured as optical multiplexers and/or demultiplexers, for example, to perform wavelength division multiplexing (WDM). In some embodiments, waveguide 164 may include a de-multiplexer, such as Arrayed Waveguide Grating (AWG) de-multiplexer, an Echelle grating, a single-mode waveguide, or a thin film filter (TFF) de-multiplexer. Waveguide 164 may comprise planar and non-planar waveguides of any type. In one example, waveguide 164 may comprise a silicon photonic waveguide based on silicon-on-isolator (SOI) platform, configured to guide electromagnetic radiation of any wavelength bands from about 0.8 micrometer to about 5.0 micrometer. In another example, waveguide 164 may support wavelengths from about 1.2 micrometer to about 1.7 micrometer in the near infrared and infrared bands for use in data communications and telecommunications.

Although only three such example optical elements are illustrated in FIG. 1B, it may be understood that PIC 104 may include more optical elements of the same or different types that enable it to function appropriately as a photonic device receiving, transforming, and transmitting optical and electrical signals.

In general, the light provided to PIC 104 may include any electromagnetic signals having information encoded therein (or, phrased differently, any electromagnetic signals modulated to include information). Often times, the electromagnetic signals are signals associated with optical amplitudes, phases, and wavelengths and, therefore, descriptions provided herein refer to “optical” signals (or light) and “optical” components. However, photonic microelectronic assembly 100 with PIC 104, as described herein, are not limited to operating with electromagnetic signals of optical spectrum and descriptions provided herein with reference to optical signals and/or optical elements are equally applicable to electromagnetic signals of any suitable wavelength, such as electromagnetic signals in near-infrared (NIR) and/or infrared (IR) bands, as well as electromagnetic signals in the RF and/or microwave bands.

PIC 104 may comprise a semiconductor material including, for example, N-type or P-type materials. PIC 104 may include, for example, a crystalline substrate formed using a bulk silicon (or other bulk semiconductor material) or a SOI structure (or, in general, a semiconductor-on-insulator structure). In some embodiments, PIC 104 may be formed using alternative materials, which may or may not be combined with silicon, that include, but are not limited to, lithium niobite, indium phosphide, silicon dioxide, germanium, silicon germanium, indium antimonide, lead telluride, indium arsenide, indium phosphide, gallium arsenide, aluminum gallium arsenide, aluminum arsenide, indium aluminum arsenide, aluminum indium antimonide, indium gallium arsenide, gallium nitride, indium gallium nitride, aluminum indium nitride or gallium antimonide, or other combinations of group Ill-N or group IV materials. In some embodiments, PIC 104 may comprise a non-crystalline material, such as polymers. In some embodiments, PIC 104 may be formed on a printed circuit board (PCB). In some embodiments, PIC 104 may be inhomogeneous, including a carrier material (such as glass or silicon carbide) as a substrate with a thin semiconductor layer over which is active surface 105. Although a few examples of the material for PIC 104 are described here, any material or structure that may serve as a foundation upon which PIC 104 may be built falls within the spirit and scope of the present disclosure.

Returning to FIG. 1A, a microelectronic assembly 100 may further include EIC 114 and XPU 128. EIC 114 may be at least partially nested in a cavity in a dielectric material of a substrate 101. The substrate 101 may include conductive pathways 196 (e.g., including conductive traces and/or conductive vias, as shown) through a dielectric material. The substrate 101 may include a set of first conductive contacts 172 on the bottom surface of the substrate 101 and a set of second conductive contacts 174 on the top surface of the substrate 101, where the conductive pathways 196 electrically couple individual ones of the first and second conductive contacts 172, 174. The substrate 101 may be manufactured using any suitable technique, such as an additive technique (e.g., a semi-additive plating process (SAP) technique), a subtractive technique, or a redistribution layer technique. In some embodiments, a dielectric material of the substrate 101 may include an oxide material, such as silicon and oxygen (e.g., in the form of silicon oxide), a nitride material, such as or silicon and nitrogen (e.g., in the form of silicon nitride), or an organic material. In some embodiments, the conductive pathways 196 in the substrate 101 may electrically couple the XPU 128 and the PIC 104 instead of the EIC 114.

EIC 114 may be electrically coupled to PIC 104 and XPU 128 by interconnects 130. Interconnects 130 may enable electrical coupling between PIC 104, EIC 114, and XPU 128. Interconnects 130 disclosed herein may take any suitable form, including solder balls for a ball grid array arrangement, pins in a pin grid array arrangement or lands in a land grid array arrangement. In some embodiments, a set of interconnects 130 may include solder 132 (e.g., solder bumps or balls that are subject to a thermal reflow to form the interconnects 130). Interconnects 130 that include solder may include any appropriate solder material, such as lead/tin, tin/bismuth, eutectic tin/silver, ternary tin/silver/copper, eutectic tin/copper, tin/nickel/copper, tin/bismuth/copper, tin/indium/copper, tin/zinc/indium/bismuth, or other alloys. In some embodiments, a set of interconnects 130 may include an anisotropic conductive material, such as an anisotropic conductive film or an anisotropic conductive paste. An anisotropic conductive material may include conductive materials dispersed in a non-conductive material. In some embodiments, an anisotropic conductive material may include microscopic conductive particles embedded in a binder or a thermoset adhesive film (e.g., a thermoset biphenyl-type epoxy resin, or an acrylic-based material). In some embodiments, the conductive particles may include a polymer and/or one or more metals (e.g., nickel or gold). For example, the conductive particles may include nickel-coated gold or silver-coated copper that is in turn coated with a polymer. In another example, the conductive particles may include nickel. When an anisotropic conductive material is uncompressed, there may be no conductive pathway from one side of the material to the other. However, when the anisotropic conductive material is adequately compressed (e.g., by conductive contacts on either side of the anisotropic conductive material), the conductive materials near the region of compression may contact each other so as to form a conductive pathway from one side of the film to the other in the region of compression. In some embodiments, interconnects 130 disclosed herein may have a pitch between about 20 microns and 200 microns (for example, between 20 microns and 75 microns, or between 75 microns and 150 microns).

EIC 114 may include an IC configured to electrically integrate with PIC 104 to achieve an intended functionality of photonic package 100. For example, EIC 114 may be an Application Specific IC (ASIC), including one or more switch or driver/receiver circuits used in optical communication systems. In some embodiments, EIC 114 may include circuitry for communicating between two or more IC dies, for example, EIC 114 may function as an embedded multi-die interconnect bridge having appropriate circuitry on/in a semiconductor substrate to connect at silicon-interconnect speeds with a small footprint as part of an Omni-Directional Interface (ODI) architecture, for example, of 2.5D packages. In some embodiments, EIC 114 may comprise active components, including one or more transistors, voltage converters, trans-impedance amplifiers (TIA), serializer and de-serializer (SERDES), clock and data recovery (CDR) components, microcontrollers, etc. In some embodiments, EIC 114 may comprise passive circuitry sufficient to enable interconnection to PIC 104 and other components in photonic package 100 without any active components. In some embodiments, EIC 114 may extend under a substantial area of PIC 104. In various embodiments, EIC 114 and PIC 104 may overlap sufficiently to enable disposing interconnects 130 with a desired pitch and number of interconnections that enable photonic package 100 to function appropriately.

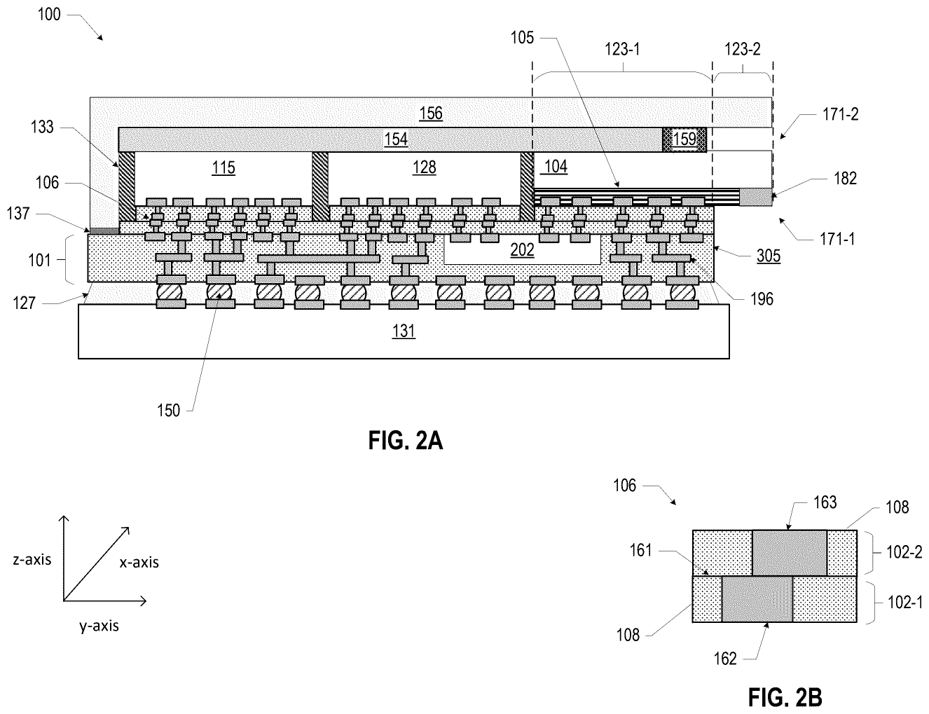

XPU 128 may include any suitable integrated chip with processing functionality, such as Central Processing Unit (CPU), Graphics Processing Unit (GPU), Field-Programmable Gate Array (FPGA), or Application-Specific IC (ASIC). In various embodiments, XPU 128 may be, or include, one or more voltage converters, Trans Impedance Amplifier (TIA), Clock and Data Recovery (CDR) components, microcontrollers, etc. Although FIG. 1A shows XPU 128 and EIC 114 as separate ICs, in some embodiments, XPU 128 may include EIC functionality, such that a microelectronic assembly 100 may include XPU 128 and may not include a separate EIC 114. In such embodiments, a bridge die, such as the bridge die 202 of FIG. 2A, may replace EIC 114. Although FIG. 1A shows XPU 128 as a single IC, in some embodiments, XPU 128 may include multiple ICs coupled by interconnects 130.

The photonic microelectronic assembly 100 of FIG. 1A may further include an insulating material 133 around and between PIC 102 and XPU 128. The insulating material 133 may include a material formed in multiple layers. In some embodiments, the insulating material 133 may be a dielectric material, such as an organic dielectric material, a fire retardant grade 4 material (FR-4), bismaleimide triazine (BT) resin, polyimide materials, glass reinforced epoxy matrix materials, or low-k and ultra low-k dielectric (e.g., carbon-doped dielectrics, fluorine-doped dielectrics, porous dielectrics, and organic polymeric dielectrics). In some embodiments, the insulating material 133 may be a mold material, such as an organic polymer with inorganic silica particles.

The microelectronic assembly 100 of FIG. 1A may also include a circuit board 131. In particular, conductive contacts 172 on a bottom surface of the substrate 101 may be electrically coupled to conductive contacts 146 on a top surface of circuit board 131 by interconnects 150. Interconnects 150 disclosed herein may take any suitable form, including any of the forms described above with reference to interconnects 130. As shown in FIG. 1A, in some embodiments, a set of interconnects 150 may include solder 136 (e.g., solder bumps or balls that are subject to a thermal reflow to form the interconnects 150). In some embodiments, the interconnects 150 disclosed herein may have a pitch between about 50 microns and 500 microns. In some embodiments, an underfill material 127 may extend between the substrate 101 and the circuit board 131 around the associated interconnects 150.

The circuit board 131 may be a motherboard, for example, and may have other components attached to it. The circuit board may include conductive pathways and other conductive contacts for routing power, ground, and signals through the circuit board, as known in the art. In some embodiments, the interconnects 150 may not couple to a circuit board 131, but may instead couple to another IC package, an interposer, or any other suitable component.

The microelectronic assembly 100 of FIG. 1A may also include an underfill material 127. In some embodiments, the underfill material 127 may extend between EIC 114 and XPU 128 and the substrate 101 around the associated interconnects 130. An underfill material 127 may be disposed around interconnects 130 and interconnects 150. The underfill material 127 may be an insulating material, such as an appropriate epoxy material. In some embodiments, the underfill material 127 may include a capillary underfill, non-conductive film (NCF), or molded underfill. In some embodiments, the underfill material 127 may include an epoxy flux that assists with soldering PIC 104 and XPU 128 to EIC 114 when forming the interconnects 130, and then polymerizes and encapsulates the interconnects 130. The underfill process may include dispensing underfill material in liquid form, allowing the material to flow and fill the space between the interstitial gaps around interconnects 130, and subjecting the assembly to a curing process, such as baking, to solidify the material. In some embodiments, an underfill material 127 may be omitted. Although FIG. 1A shows two separate underfill 127 portions under PIC 104 and XPU 128, the underfill 127 may be a single underfill 127 under PIC 104 and XPU 128. The underfill material 127 may be selected to have a coefficient of thermal expansion (CTE) that may mitigate or minimize the stress between PIC 104, EIC 114, XPU 128, substrate 101, and circuit board 131 arising from uneven thermal expansion in the microelectronic assembly 100. In some embodiments, the CTE of the underfill material 127 may have a value that is intermediate to the CTE of the substrate 101 (e.g., the CTE of the dielectric material of the substrate 101) and a CTE of the insulating material of PIC 104, EIC 114, and/or XPU 128.

In some embodiments, one or more levels of solder resist (e.g., epoxy liquid, liquid photoimageable dielectrics, dry film photoimageable dielectrics, acrylics, solvents) may be provided in an IC package described herein and may not be labeled or shown to avoid cluttering the drawings. Solder resist may be a liquid or dry film material including photoimageable dielectrics. In some embodiments, solder resist may be non-photoimageable.

Although FIG. 1A shows the microelectronic assembly 100 having two PICs 104, two EIC 114, a single XPU 128, and two barrier materials 158, a microelectronic assembly 100 may have any suitable number and arrangement of PICs 104, EICs 114, XPUs 128, and barrier materials 158, and any suitable number and arrangement electrical and optical connections therebetween. A microelectronic assembly 100 may include any suitable number and arrangement of components, including as described below with reference to FIGS. 3-5. Many of the elements of the microelectronic assembly 100 of FIG. 1 are included in other ones of the accompanying drawings; the discussion of these elements is not repeated when discussing these drawings, and any of these elements may take any of the forms disclosed herein. A number of elements are illustrated in FIG. 1 as included in the microelectronic assembly 100 may not be illustrated in other ones of the accompanying drawings but may be included in the microelectronic assembly 100. Further, a number of elements are illustrated in FIG. 1 as included in the microelectronic assembly 100, but a number of these elements may not be present in a microelectronic assembly 100. For example, in various embodiments, the insulating material 133, the underfill material 127, and the circuit board 131 may not be included. In some embodiments, individual ones of the microelectronic assemblies 100 disclosed herein may serve as a system-in-package (SiP) in which multiple dies having different functionality are included. In such embodiments, the microelectronic assembly 100 may be referred to as an SiP.

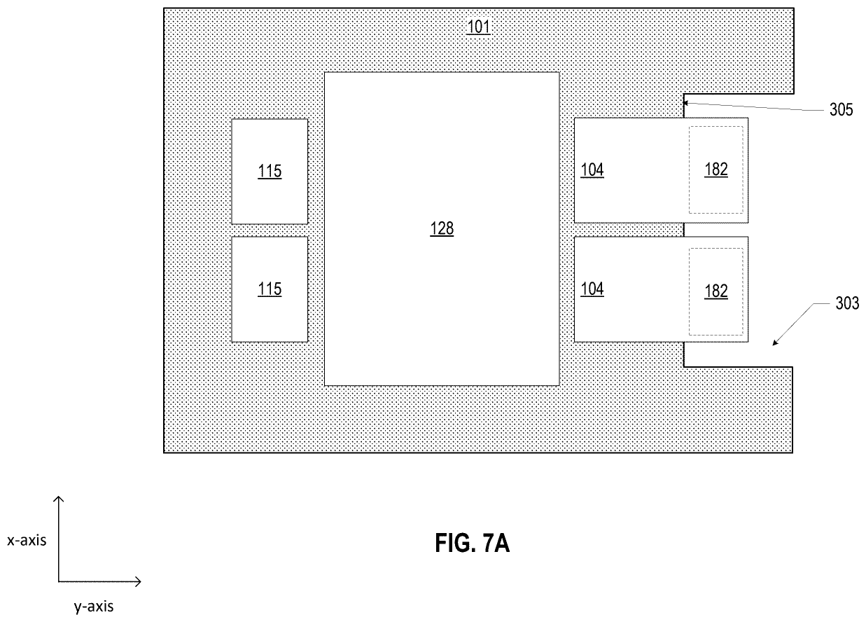

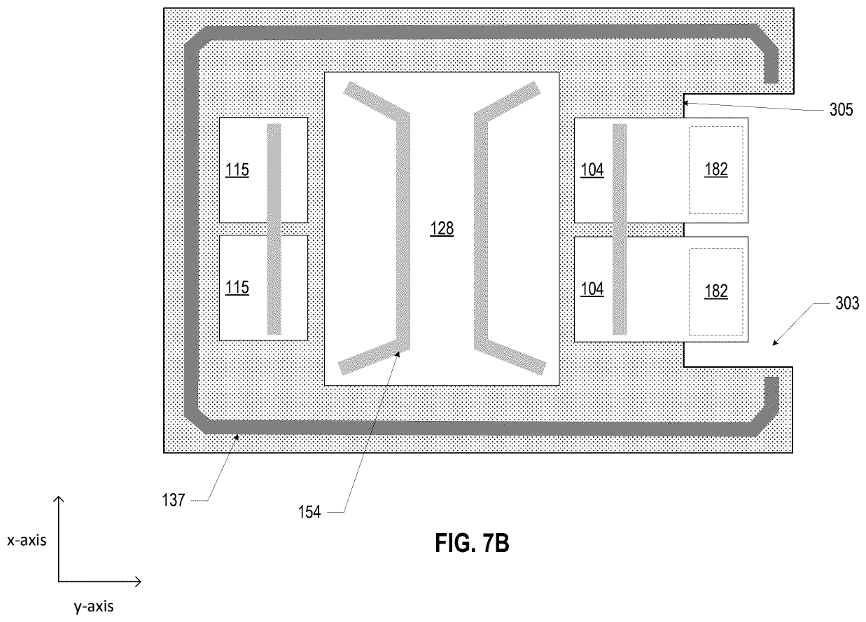

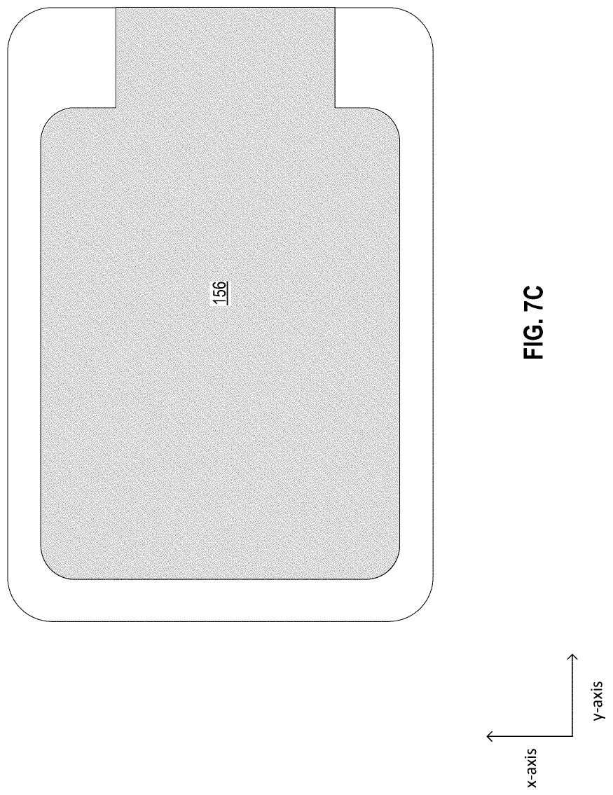

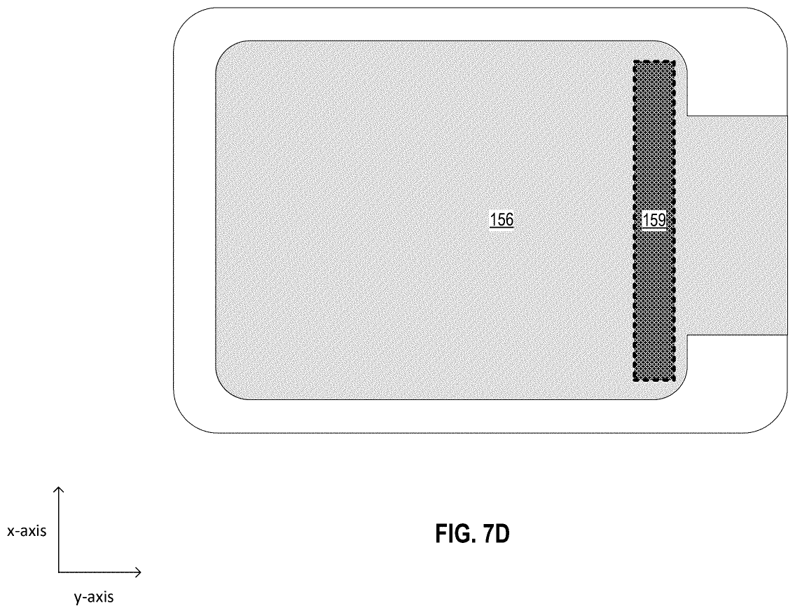

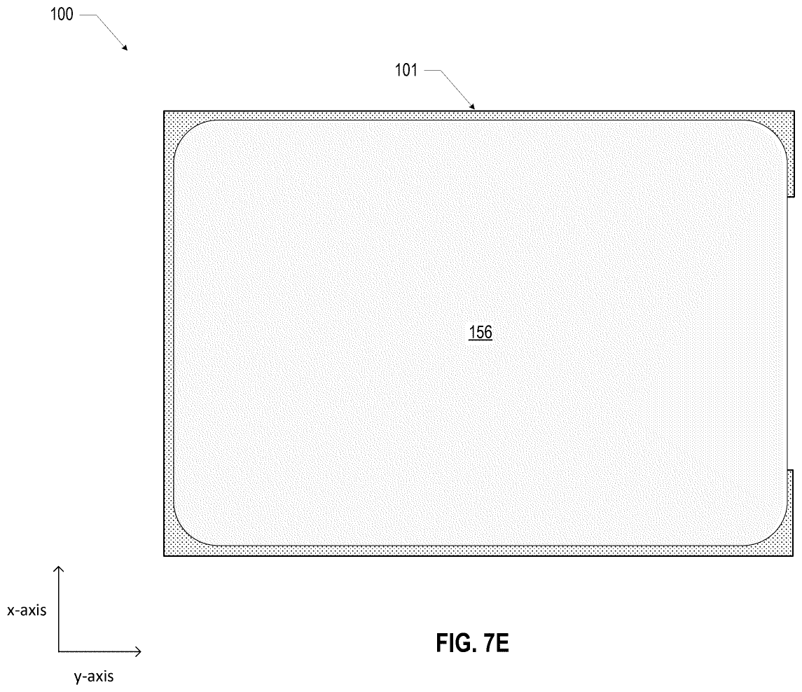

FIG. 2A is a schematic cross-sectional view of another example microelectronic assembly according to some embodiments of the present disclosure. The configuration of the embodiment shown in the figure is like that of FIG. 1A, except for differences as described further. The configuration of microelectronic assembly 100 as described herein includes a barrier material 159 at a second surface 171-2 of the PIC 104 that is opposite a first surface 171-1, where the PIC 104 overhangs the substrate 101 and the fiber alignment region 182 is exposed. The barrier material 159 may include a same material as the barrier material 158, which is described above with reference to FIG. 1A. The barrier material 159 may further include a low modulus, elastic polymer composite, such as silicone or other rubber, an adhesive tape, or a foam tape. A barrier material 159 may have a width (e.g., y-dimension) between 1 millimeter and 3 millimeters and a thickness (e.g., z-dimension) between 30 microns and 50 microns (e.g., between the top surface 171-2 of the PIC 104 and a bottom surface of the heat transfer structure 156). As described below with reference to FIG. 7, a barrier material 159 may be attached to a heat transfer structure 156 before being attached to PIC 104 during assembly of the microelectronic assembly 100.

As shown in FIG. 2A, the configuration of microelectronic assembly 100 does not include a separate EIC 114, and further includes PIC 104 and XPU 128 electrically coupled to bridge die 202 by interconnects 106. A bridge die 202 at least partially nested in a dielectric material of the substrate 101 (e.g., partially surrounded by or embedded in a dielectric material of the substrate 101). A bridge die 202 may comprise appropriate circuitry on/in a semiconductor substrate to connect at silicon-interconnect speeds with a small footprint. In some embodiments, bridge die 202 may comprise active components, such as transistors and diodes in addition to bridge circuitry including metallization traces, vias and passive components for enabling electrical coupling between two ICs; in other embodiments, bridge die 202 may include bridge circuitry including metallization traces, vias and passive components for enabling electrical coupling between PIC 104 and XPU 128, and may not include active components.

A microelectronic assembly 100 may further include a die 115 electrically coupled to XPU 128 by conductive pathways 196 in the substrate 101 and by interconnects 106. A die 115 may include circuitry to perform any desired functionality. For example, a die 115 may include a transceiver die, a digital to analog converter die, an I/O die, a Platform Controller Hub (PCH), a memory die, or a high bandwidth memory (HBM) die. Although FIG. 2A shows a single die 115 having a particular arrangement, a microelectronic assembly 100 may include any number and arrangement of die 115.

A microelectronic assembly 100 may further include a sealant 137 between the heat transfer structure 156 and a surface of the substrate 101. The sealant 137 may include any suitable material for physically attaching or securing the heat transfer structure 156 to the substrate 101. A material of the sealant 137 may include a silicone-based polymer material.

FIG. 2B is a schematic cross-sectional view of a detail of a particular one of interconnects 106 in microelectronic assembly 100. Interconnects 106 have a pitch of less than 10 micrometers between adjacent interconnects 106. In some embodiments, interconnects 106 may have a pitch between 2 microns and 150 microns (for example, between 2 microns and 20 microns, between 20 microns and 75 microns, or between 75 microns and 150 microns). In a general sense, interconnect 106 may include, at an interface 161 between layers 102-1 and 102-2, metal-metal bonds between bond-pad 162 of layer 102-1 and bond-pad 163 of layer 102-2, and dielectric-dielectric bonds (e.g., oxide-oxide bonds) in a dielectric material 108 of layers 102-1 and 102-2. In some embodiments, the layer 102-2 may be included on PIC 104 and XPU 128, and layer 102-1 may be included on the substrate 101. Bond-pad 162 of layer 102-1 may bond with bond-pad 163 of layer 102-2. Dielectric material 108 in layers 102-1 and 102-2 may bond with each other. A dielectric material 108 may include inorganic materials, for example, silicon and one or more of oxygen, nitrogen, and carbon (e.g., in the form of silicon oxide, silicon nitride, or silicon carbide), and/or other forms of inorganic dielectric material typically used as interlayer dielectric (ILD) in semiconductor devices. The bonded metal and dielectric materials form interconnect 106, comprising hybrid bonds, providing electrical and mechanical coupling between layers 102-1 and 102-2. In various embodiments, interconnects 106 may have a linear dimension of less than 5 micrometers and a pitch of less than 10 micrometers between adjacent interconnects.

FIG. 3 is a schematic top view of the example microelectronic assembly of FIG. 1A according to some embodiments of the present disclosure. The configuration of microelectronic assembly 100 shown in FIG. 3 includes a substrate 101, an XPU 128, four PICs 104, and a barrier material 158. The TIM 154, the heat transfer structure 156, and the insulating material 133 in FIG. 1A have been omitted from FIG. 3 to avoid cluttering and to simplify the drawing. The microelectronic assembly 100 includes the XPU 128 in a center of the substrate 101 and two PICs 104 (e.g., four total PICs 104) at two opposing sides of the XPU 128. The PICs 104 are positioned at an edge 305 of the substrate 101 (e.g., positioned at an edge 305 of a cut-out portion 303 of the substrate 101) with a portion of the PIC 104 extending beyond the edge of the substrate 101 such that the fiber alignment region 182 is exposed at a bottom surface (e.g., the first surface 171-1 of FIG. 1A) of the PIC 104 (e.g., as indicated by the dotted lines). A barrier material 158 may be at a top surface (e.g., a second surface 171-2 of FIG. 1A) of the PICs 104 adjacent to the edge 305 of the substrate 101 and may extend on to a surface of the substrate 101. A barrier material 158 may function to contain a TIM 154 and prevent the TIM 154 from spreading to contaminate the fiber alignment region 182. In particular, a first barrier material 158-1 may be on a top surface of the first PIC 104-1, the second PIC 104-2, and the substrate 101 adjacent to first edge 305-1, and a second barrier material 158-2 may be on a top surface of the third PIC 104-3, the fourth PIC 104-4, and the substrate 101 adjacent to second edge 305-2. The barrier material 158 may have any suitable dimensions and may include any suitable material, as described above with reference to FIG. 1A. The barrier material 158 may have any suitable shape or pattern to prevent the TIM 154 from spreading including, as shown, a straight portion in the middle and angled portions at the ends to contain the TIM 154 to the center of the substrate 101 (e.g., on the XPU 128 and on the portions of the PICs 104 that do not overhang the substrate 101). In some embodiments, a barrier material 158 may be on the top surface of the PIC 104 and may not extend beyond the PIC 104 (e.g., may not be on a surface of the substrate 101). In some embodiments, a substrate 101 may not include a cut-out 303.

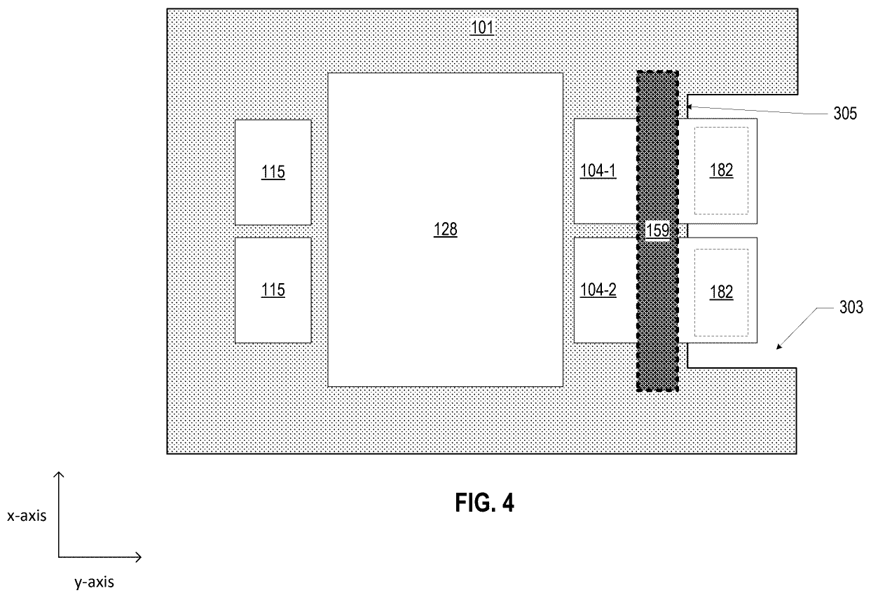

FIG. 4 is a schematic top view of the example microelectronic assembly of FIG. 2A according to some embodiments of the present disclosure. The configuration of microelectronic assembly 100 shown in FIG. 4 includes a substrate 101, an XPU 128, two die 115, two PICs 104, and a barrier material 159. The TIM 154 and the heat transfer structure 156 in FIG. 2A have been omitted from FIG. 4 to avoid cluttering and to simplify the drawing. The microelectronic assembly 100 includes the XPU 128 in a center of the substrate 101, two die 115, and two PICs 104, where dies 115 and PICs 104 are at opposite sides of the XPU 128. The PICs 104 are positioned at an edge 305 of the substrate 101 (e.g., positioned at an edge 305 of a cut-out portion 303 of the substrate 101) with a portion of the PIC 104 extending beyond the edge of the substrate 101 such that the fiber alignment region 182 is exposed at a bottom surface (e.g., the first surface 171-1 of FIG. 2A) of the PIC 104 (e.g., as indicated by the dotted lines). A barrier material 159 may be at a top surface (e.g., a second surface 171-2 of FIG. 2A) of the PICs 104 adjacent to the edge 305 of the substrate 101 and may extend on a surface of the substrate 101. A barrier material 159 may function to contain a TIM 154 and prevent the TIM 154 from spreading to contaminate the fiber alignment region 182 of the PIC 104. In particular, a barrier material 159 may be at a top surface of the first PIC 104-1, a tops surface of the second PIC 104-2, and on a surface of the substrate 101 adjacent to the edge 305. The barrier material 159 may have any suitable dimensions and may include any suitable material, as described above with reference to FIG. 2A. The barrier material 159 may have any suitable shape to prevent the TIM 154 from spreading including, as shown, a rectangular shape to contain the TIM 154 to the center of the substrate 101 (e.g., on the XPU 128, on the die 115, and on the portions of the PICs 104 that do not overhang the substrate 101). In some embodiments, a barrier material 159 may be on the top surface of the PIC 104 and may not extend beyond the PIC 104 (e.g., may not be on a surface of the substrate 101). In some embodiments, a substrate 101 may not include a cut-out 303.

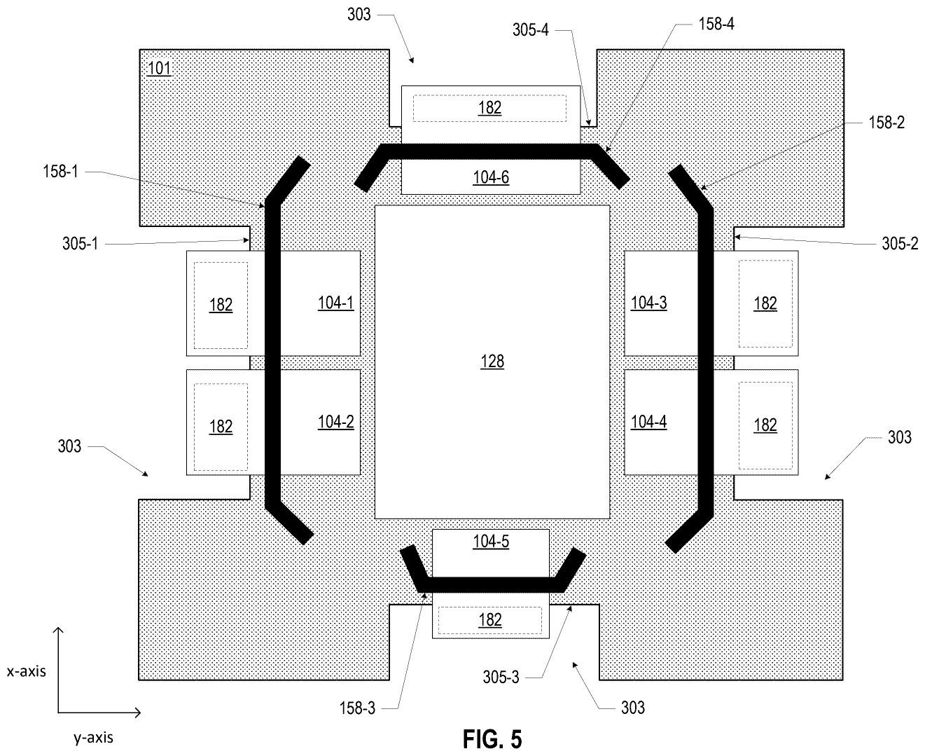

FIG. 5 is a schematic top view of a portion of another example microelectronic assembly according to some embodiments of the present disclosure. The configuration of microelectronic assembly 100 shown in FIG. 5 includes a substrate 101, an XPU 128, six PICs 104, and a barrier material 158. The TIM 154 and the heat transfer structure 156 at a top of the microelectronic assembly 100 have been omitted to avoid cluttering and to simplify the drawing. The microelectronic assembly 100 includes the XPU 128 in a center of the substrate 101 and PICs 104 (e.g., six total PICs 104) at each of four sides of the XPU 128, where the PICs 104 are positioned at an edge 305 of the substrate 101 (e.g., positioned at an edge 305 of a cut-out portion 303 of the substrate 101) with a portion of the PIC 104 extending beyond the edge of the substrate 101 such that the fiber alignment region 182 is exposed at a bottom surface (e.g., similar to the first surface 171-1 of FIG. 1A) of the PIC 104 (e.g., as indicated by the dotted lines). A barrier material 158 may be at a top surface (e.g., similar to the second surface 171-2 of FIG. 1A) of the PICs 104 adjacent to the edge 305 of the substrate 101 and may extend on a surface of the substrate 101. A barrier material 158 may function to contain a TIM 154 and prevent the TIM 154 from spreading to contaminate the fiber alignment region 182. In particular, a first barrier material 158-1 may be at a top surface of first PIC 104-1 and second PIC 104-2 adjacent to first edge 305-1, a second barrier material 158-2 may be at a top surface of third PIC 104-3 and fourth PIC 104-4 adjacent to second edge 305-2, a third barrier material 158-3 may be at a top surface of fifth PIC 104-5 adjacent to third edge 305-3, and a fourth barrier material 158-4 may be at a top surface of sixth PIC 104-6 adjacent to fourth edge 305-4. The respective barrier material 158 (e.g., 158-1, 158-2, 158-3, 158-4) may extend beyond the respective PICs (e.g., 104-1, 104-2, 104-3, 104-4, 104-5, 104-6) and on to the surface of the substrate 101. The barrier material 158 may have any suitable dimensions and may include any suitable material, as described above with reference to FIG. 1A. The barrier material 158 may have any suitable shape to prevent the TIM 154 from spreading including, as shown, a straight portion in the middle and angled portions at the ends to contain the TIM 154 to the center of the substrate 101 (e.g., on the XPU 128 and on the portions of the PICs 104 that do not overhang the substrate 101). The respective barrier material 158 (e.g., 158-1, 158-2, 158-3, 158-4) may have different shapes, widths (e.g., y-dimension), and lengths (e.g., x-dimension) depending on the number, size, and arrangement of PICs 104. In some embodiments, a barrier material 158 may be on the top surface of the PIC 104 and may not extend beyond the PIC 104 (e.g., may not be on a surface of the substrate 101). In some embodiments, a substrate 101 may not include a cut-out 303.

### Example Methods

Any suitable techniques may be used to manufacture the microelectronic assemblies 100 disclosed herein. For example, FIGS. 6A-6E are top views of various stages in an example process for manufacturing the microelectronic assembly 100 of FIG. 1A, in accordance with various embodiments. Although the operations discussed below with reference to FIGS. 6A-6E (and others of the accompanying drawings representing manufacturing processes) are illustrated in a particular order, these operations may be performed in any suitable order. Further, additional operations which are not illustrated may also be performed without departing from the scope of the present disclosure. Also, various ones of the operations discussed herein with respect to FIGS. 6A-6E may be modified in accordance with the present disclosure to fabricate others of microelectronic assembly 100 disclosed herein.

FIGS. 6A-6E are simplified top views illustrating various manufacturing steps of the example microelectronic assembly of FIG. 1A according to some embodiments of the present disclosure. FIG. 6A illustrates an assembly subsequent to electrically coupling XPU 128 and PICs 104 (e.g., PIC 104-1, 104-2, 104-3, 104-4) to substrate 101 by interconnects (e.g., interconnects 130 or interconnects 106, not shown). The PICs 104 are positioned at an edge 305 of the substrate 101 (e.g., positioned at an edge 305 of a cut-out portion 303 of the substrate 101) with a portion of the PIC 104 extending beyond the edge of the substrate 101 such that the fiber alignment region 182 is exposed at a bottom surface (e.g., the first surface 171-1 of FIG. 1A) of the PIC 104 (e.g., as indicated by the dotted lines). In particular, the first PIC 104-1 and the second PIC 104-2 may be at a first edge 305-1 of the substrate 101 with a portion of the first and second PICs 104-1, 104-2 extending beyond the edge of the substrate 101 such that the fiber alignment region 182 is exposed at a bottom surface (e.g., the first surface 171-1 of FIG. 1A) of the PIC 104 (e.g., as indicated by the dotted lines), and the third PIC 104-3 and the fourth PIC 104-4 may be at a second edge 305-2 of the substrate 101 with a portion of the third and fourth PICs 104-3, 104-4 extending beyond the second edge 305-2 of the substrate 101 such that the fiber alignment region 182 is exposed at a bottom surface (e.g., the first surface 171-1 of FIG. 1A) of the PIC 104 (e.g., as indicated by the dotted lines). In some embodiments, the interconnects (e.g., interconnects 130) may include solder. In such embodiments, the assembly of FIG. 6A may be subjected to a solder reflow process during which solder components of the interconnects melt and bond to mechanically and electrically couple XPU 128 and PICs 104 to the top surface of the substrate 101. In some embodiments, an underfill material 127 (not shown) may be deposited around the interconnects 130 and an insulating material 133 (not shown) may be deposited around XPU 128 and PICs 104.

FIG. 6B illustrates an assembly subsequent to depositing a barrier material 158 and partially curing the barrier material 158. A barrier material 158 may be at a top surface (e.g., a second surface 171-2 of FIG. 1A) of the PICs 104 adjacent to the edge 305 of the substrate 101 and may extend on a surface of the substrate 101. In particular, a first barrier material 158-1 may be at a top surface of first PIC 104-1, second PIC 104-2, and substrate 101 adjacent to first edge 305-1, and a second barrier material 158-2 may be at a top surface of third PIC 104-3, fourth PIC 104-4, and substrate 101 adjacent to second edge 305-2. In some embodiments, the barrier material 158 may not be deposited on a surface of the substrate 101. The barrier material 158 may be deposited using any suitable technique, including an auger dispense process. In some embodiments, the barrier material 158 is dispensed beginning off the first PIC 104-1 (e.g., on the surface of the substrate 101), continues on the first PIC 104-1, continues between the first PIC 104-1 and the second PIC 104-2, continues on the second PIC 104-2, and then continues off the second PIC 104-2 (e.g., on the surface of the substrate 101). The barrier material 158 after deposition may have a width (e.g., y-dimension) between 80 microns and 200 microns, and a thickness (e.g., z-dimension as shown in FIG. 1A) between 30 microns and 100 microns. The second barrier material 158-2 may be deposited using a similar method. Subsequent to depositing, the barrier material 158 may be partially cured by applying heat to a bottom surface of the assembly of FIG. 6B. For example, in some embodiments, the assembly of FIG. 6B, including the barrier material 158, may be exposed to heat for a period of time. For example, a pedestal may be heated to a temperature between 115 degrees Celsius and 125 degrees Celsius and the assembly of 6B may be placed on the pre-heated pedestal for between 30 seconds and 60 seconds. Partially curing the barrier material 158 softens the barrier material 158 (e.g., making is more pliable or compressible), such that when a heat transfer structure 156 is attached, as described below with reference to FIG. 6E, the assembly is compressed, and a final thickness of the barrier material 158 is reduced to between 30 microns and 50 microns, as described above with reference to FIG. 1A.

FIG. 6C illustrates an assembly subsequent to depositing a sealant 137 along outside edges of a substrate 101. The sealant 137 may include any suitable material to physically attach a heat transfer structure 156 to the substrate 101, as described above with reference to FIG. 2A, and may be dispensed using any suitable technique, including an auger dispense process.

FIG. 6D illustrates an assembly subsequent to depositing a TIM 154 to a top surface of XPU 128 and the PICs 104. The TIM 154 may be deposited on a top surface (e.g., the second surface 171-2 in FIG. 1A) of the PICs 104 at an inner side (e.g., towards a center of the substrate 101) of the barrier material 158. A barrier material 158 may function to contain a TIM 154 and prevent the TIM 154 from spreading to contaminate the fiber alignment region 182 of the PICs 104. The TIM 154 may be dispensed using any suitable technique, including an auger dispense process. The TIM 154 may be deposited in a particular pattern, as shown, and, after heat is applied subsequent to attaching the heat transfer structure 156 as shown in FIG. 6E, may spread to cover a top surface of XPU 128 and a top surface of the PICs 104 to the barrier material 158, as shown in FIG. 1A.

FIG. 6E illustrates an assembly subsequent to attaching a heat transfer structure 156 to a top surface of the assembly of FIG. 6D and applying heat to a top surface and a bottom surface of the assembly of FIG. 6E to spread the TIM 154 and activate the sealant 137 to physically attach the heat transfer structure 156 to a top surface of the substrate 101. In some embodiments, the heat transfer structure 156 may undergo compression before, during, and/or after the application of heat, such that the TIM 154 and the barrier material 158 may be compressed to a desired thickness. Further, during attachment of the heat transfer structure 156, the TIM 154 may spread (e.g., due to compression), and the barrier material 158 may be fully cured and may constrain the TIM 154 from spreading to contaminate the fiber alignment region 182 of the PIC 104.

FIGS. 7A-7E are simplified top views illustrating various manufacturing steps of the example microelectronic assembly of FIG. 2A according to some embodiments of the present disclosure. FIG. 7A illustrates an assembly subsequent to electrically coupling dies 115 (e.g., die 115-1, 115-2), XPU 128, and PICs 104 (e.g., PIC 104-1, 104-2) to substrate 101 by interconnects (e.g., interconnects 130 or interconnects 106, not shown). As shown in FIG. 7A, the dies 115 are positioned at a first side of the XPU 128 and the PICs 104 are positioned at a second side opposite the first side of the XPU 128. The PICs 104 are positioned at an edge 305 of the substrate 101 (e.g., positioned at an edge 305 of a cut-out portion 303 of the substrate 101) with a portion of the PICs 104 extending beyond the edge of the substrate 101 such that the fiber alignment region 182 is exposed at a bottom surface (e.g., the first surface 171-1 of FIG. 2A) of the PICs 104 (e.g., as indicated by the dotted lines). In some embodiments, the interconnects (e.g., interconnects 106) may include hybrid bonds. In such embodiments, the assembly of FIG. 7A may be subjected to a hybrid bonding process during which dielectric-dielectric bonds and metal-metal bonds form to mechanically and electrically couple dies 115, XPU 128, and PICs 104 to the top surface of the substrate 101. In some embodiments, an insulating material 133 (not shown) may be deposited around dies 115, XPU 128, and PICs 104.

FIG. 7B illustrates an assembly subsequent to depositing a TIM 154 to a top surface of the dies 115, XPU 128 and the PICs 104, and to depositing a sealant 137 along outside edges of a substrate 101. The TIM 154 may be dispensed using any suitable technique, including an auger dispense process. The TIM 154 may be deposited in a particular pattern, as shown, and, after heat is applied subsequent to attaching the heat transfer structure 156, as described with reference to FIG. 7E, may spread to cover a top surface of the dies 115, XPU 128, and a top surface of PICs 104 (e.g., to the barrier material 159, as shown in FIG. 2A). The sealant 137 may include any suitable material to physically attach a heat transfer structure 156 to the substrate 101, as described above with reference to FIG. 2A, and may be dispensed using any suitable technique, including an auger dispense process.

FIG. 7C illustrates a bottom surface of a heat transfer structure 156. In some embodiments, a heat transfer structure 156 may have flat, linear top and bottom surfaces, and may further have sidewalls or posts that extend from the bottom surface and attach to one or more edges of a substrate 101 by a sealant 137 (e.g., as shown in FIG. 2A). In some embodiments, as shown in FIG. 7C, a heat transfer structure 156 may have a bottom surface with a contoured form. The contoured form provides space for the heat transfer structure 156 to cover the dies 115, XPU 128, and the PICs 104, and to form a contact region along one or more edges of the substrate 101 for attachment to the substrate 101 by a sealant 137 (e.g., as shown in FIG. 2A).

FIG. 7D illustrates the heat transfer structure of FIG. 7C subsequent to depositing a barrier material 159 on the bottom surface of the heat transfer structure 156. The barrier material 159 may be deposited such that, when the heat transfer structure 156 is inverted and attached to the assembly of FIG. 7B, the barrier material 159 is positioned at a top surface of the PICs 104 (e.g., PIC 104-1, 104-2) adjacent to the edge 305 of the substrate 101 and, in some embodiments, may extend on to a surface of the substrate 101. The barrier material 159 may be deposited using any suitable technique, including spin coating or blade coating, or, if the barrier material 159 includes an adhesive tape or a foam tape, the barrier material 159 may be deposited using pick-and-place tooling. The barrier material 159 after deposition may have a width (e.g., y-dimension) between 1 millimeter and 3 millimeters, and a thickness between 40 microns and 100 microns (e.g., z-dimension as shown in FIG. 2A).

FIG. 7E illustrates an assembly subsequent to inverting and attaching a bottom surface of the heat transfer structure 156 with the barrier material 159 (e.g., the assembly of FIG. 7D) to a top surface of the assembly of FIG. 7B and applying heat and force to a top surface and a bottom surface of the assembly of FIG. 7E to spread the TIM 154 and activate the sealant 137 to physically attach the heat transfer structure 156 to a top surface of the substrate 101. In some embodiments, the heat transfer structure 156 may undergo compression before, during, and/or after the application of heat, such that the TIM 154 and the barrier material 159 may be compressed such that a thickness (e.g., z-height) of the barrier material 159 may be reduced to between 30 microns and 50 microns, and a width (e.g., y-dimension) may be between 1 millimeter and 3 millimeters, as described above with reference to FIG. 2A. Further, during attachment of the heat transfer structure 156, the TIM 154 may melt (e.g., may spread) and the barrier material 159 may be fully cured and may constrain the TIM 154 from spreading to contaminate the fiber alignment region 182 of the PIC 104.

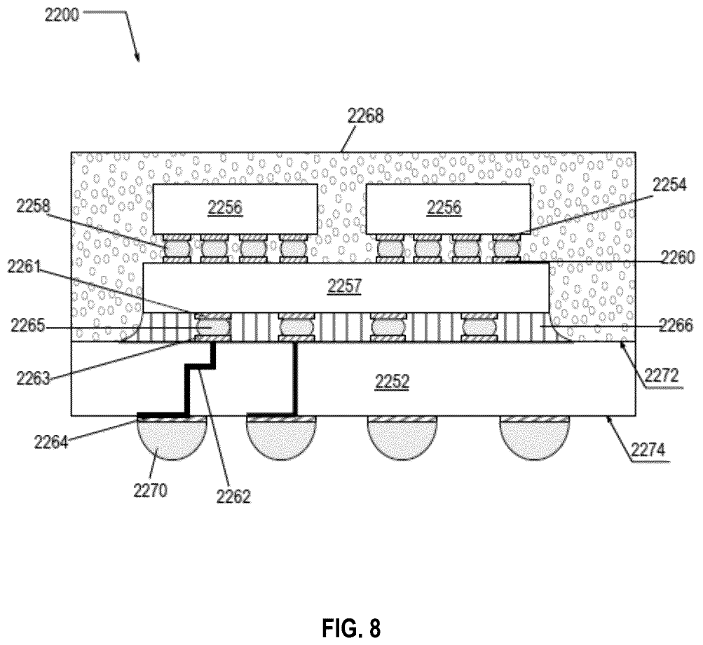

The packages disclosed herein, e.g., any of the microelectronic assemblies 100 or any further embodiments described herein, may be included in any suitable electronic component. FIGS. 8-10 illustrate various examples of packages, assemblies, and devices that may be used with or include any of the IC packages as disclosed herein.

FIG. 8 is a side, cross-sectional view of an example IC package 2200 that may include IC packages in accordance with any of the embodiments disclosed herein. In some embodiments, the IC package 2200 may be a SiP.

As shown in the figure, package substrate 2252 may be formed of an insulator (e.g., a ceramic, a buildup film, an epoxy film having filler particles therein, etc.), and may have conductive pathways extending through the insulator between first face 2272 and second face 2274, or between different locations on first face 2272, and/or between different locations on second face 2274. These conductive pathways may take the form of any of the interconnect structures comprising lines and/or vias.

Package substrate 2252 may include conductive contacts 2263 that are coupled to conductive pathway 2262 through package substrate 2252, allowing circuitry within dies 2256 and/or interposer 2257 to electrically couple to various ones of conductive contacts 2264 (or to other devices included in package substrate 2252, not shown).

IC package 2200 may include interposer 2257 coupled to package substrate 2252 via conductive contacts 2261 of interposer 2257, first-level interconnects 2265, and conductive contacts 2263 of package substrate 2252. First-level interconnects 2265 illustrated in the figure are solder bumps, but any suitable first-level interconnects 2265 may be used, such as solder bumps, solder posts, or bond wires.

IC package 2200 may include one or more dies 2256 coupled to interposer 2257 via conductive contacts 2254 of dies 2256, first-level interconnects 2258, and conductive contacts 2260 of interposer 2257. Conductive contacts 2260 may be coupled to conductive pathways (not shown) through interposer 2257, allowing circuitry within dies 2256 to electrically couple to various ones of conductive contacts 2261 (or to other devices included in interposer 2257, not shown). First-level interconnects 2258 illustrated in the figure are solder bumps, but any suitable first-level interconnects 2258 may be used, such as solder bumps, solder posts, or bond wires. As used herein, a “conductive contact” may refer to a portion of electrically conductive material (e.g., metal) serving as an interface between different components; conductive contacts may be recessed in, flush with, or extending away from a surface of a component, and may take any suitable form (e.g., a conductive pad or socket).

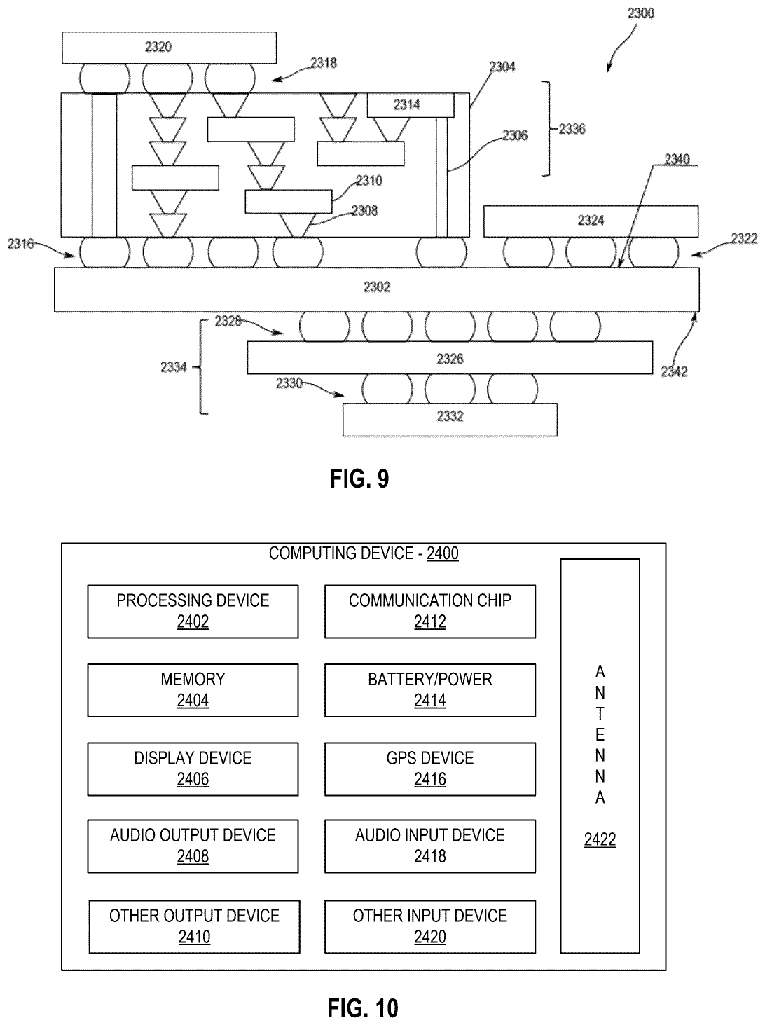

In some embodiments, underfill material 2266 may be disposed between package substrate 2252 and interposer 2257 around first-level interconnects 2265, and mold 2268 may be disposed around dies 2256 and interposer 2257 and in contact with package substrate 2252. In some embodiments, underfill material 2266 may be the same as mold 2268. Example materials that may be used for underfill material 2266 and mold 2268 are epoxies as suitable. Second-level interconnects 2270 may be coupled to conductive contacts 2264. Second-level interconnects 2270 illustrated in the figure are solder balls (e.g., for a ball grid array (BGA) arrangement), but any suitable second-level interconnects 2270 may be used (e.g., pins in a pin grid array arrangement or lands in a land grid array arrangement). Second-level interconnects 2270 may be used to couple IC package 2200 to another component, such as a circuit board (e.g., a motherboard), an interposer, or another IC package, as known in the art and as discussed below with reference to FIG. 9.

In various embodiments, any of dies 2256 may be microelectronic assembly 100, as described herein. In embodiments in which IC package 2200 includes multiple dies 2256, IC package 2200 may be referred to as a multi-chip package (MCP). Dies 2256 may include circuitry to perform any desired functionality. For example, besides one or more of dies 2256 being microelectronic assembly 100 as described herein, one or more of dies 2256 may be logic dies (e.g., silicon-based dies), one or more of dies 2256 may be memory dies (e.g., HBM), etc. In some embodiments, any of dies 2256 may be implemented as discussed with reference to any of the previous figures. In some embodiments, at least some of dies 2256 may not include implementations as described herein.

Although IC package 2200 illustrated in the figure is a flip-chip package, other package architectures may be used. For example, IC package 2200 may be a BGA package, such as an embedded wafer-level ball grid array (eWLB) package. In another example, IC package 2200 may be a wafer-level chip scale package (WLCSP) or a panel fan-out (FO) package. Although two dies 2256 are illustrated in IC package 2200, IC package 2200 may include any desired number of dies 2256. IC package 2200 may include additional passive components, such as surface-mount resistors, capacitors, and inductors disposed over first face 2272 or second face 2274 of package substrate 2252, or on either face of interposer 2257. More generally, IC package 2200 may include any other active or passive components known in the art.

In some embodiments, no interposer 2257 may be included in IC package 2200; instead, dies 2256 may be coupled directly to conductive contacts 2263 at first face 2272 by first-level interconnects 2265.

FIG. 9 is a cross-sectional side view of an IC device assembly 2300 that may include components having one or more microelectronic assembly 100, in accordance with any of the embodiments disclosed herein. IC device assembly 2300 includes a number of components disposed over a circuit board 2302 (which may be, e.g., a motherboard). IC device assembly 2300 includes components disposed over a first face 2340 of circuit board 2302 and an opposing second face 2342 of circuit board 2302; generally, components may be disposed over one or both faces 2340 and 2342. In particular, any suitable ones of the components of IC device assembly 2300 may include any of the one or more microelectronic assembly 100, in accordance with any of the embodiments disclosed herein; e.g., any of the IC packages discussed below with reference to IC device assembly 2300 may take the form of any of the embodiments of IC package 2200 discussed above with reference to FIG. 8.

In some embodiments, circuit board 2302 may be a PCB including multiple metal layers separated from one another by layers of insulator and interconnected by electrically conductive vias. Any one or more of the metal layers may be formed in a desired circuit pattern to route electrical signals (optionally in conjunction with other metal layers) between the components coupled to circuit board 2302. In other embodiments, circuit board 2302 may be a non-PCB package substrate.

As illustrated in the figure, in some embodiments, IC device assembly 2300 may include a package-on-interposer structure 2336 coupled to first face 2340 of circuit board 2302 by coupling components 2316. Coupling components 2316 may electrically and mechanically couple package-on-interposer structure 2336 to circuit board 2302, and may include solder balls (as shown), male and female portions of a socket, an adhesive, an underfill material, and/or any other suitable electrical and/or mechanical coupling structure.

Package-on-interposer structure 2336 may include IC package 2320 coupled to interposer 2304 by coupling components 2318. Coupling components 2318 may take any suitable form depending on desired functionalities, such as the forms discussed above with reference to coupling components 2316. In some embodiments, IC package 2320 may be or include IC package 2200, e.g., as described above with reference to FIG. 8. In some embodiments, IC package 2320 may include at least one microelectronic assembly 100 as described herein. Microelectronic assembly 100 is not specifically shown in the figure in order to not clutter the drawing.

Although a single IC package 2320 is shown in the figure, multiple IC packages may be coupled to interposer 2304; indeed, additional interposers may be coupled to interposer 2304. Interposer 2304 may provide an intervening package substrate used to bridge circuit board 2302 and IC package 2320. Generally, interposer 2304 may redistribute a connection to a wider pitch or reroute a connection to a different connection. For example, interposer 2304 may couple IC package 2320 to a BGA of coupling components 2316 for coupling to circuit board 2302.

In the embodiment illustrated in the figure, IC package 2320 and circuit board 2302 are attached to opposing sides of interposer 2304. In other embodiments, IC package 2320 and circuit board 2302 may be attached to a same side of interposer 2304. In some embodiments, three or more components may be interconnected by way of interposer 2304.

Interposer 2304 may be formed of an epoxy resin, a fiberglass-reinforced epoxy resin, a ceramic material, or a polymer material such as polyimide. In some implementations, interposer 2304 may be formed of alternate rigid or flexible materials that may include the same materials described above for use in a semiconductor substrate, such as silicon, germanium, and other group Ill-V and group IV materials. Interposer 2304 may include metal interconnects 2308 and vias 2310, including but not limited to TSVs 2306. Interposer 2304 may further include embedded devices 2314, including both passive and active devices. Such devices may include, but are not limited to, capacitors, decoupling capacitors, resistors, inductors, fuses, diodes, transformers, sensors, ESD devices, and memory devices. More complex devices such as radio frequency (RF) devices, power amplifiers, power management devices, antennas, arrays, sensors, and microelectromechanical systems (MEMS) devices may also be formed on interposer 2304. Package-on-interposer structure 2336 may take the form of any of the package-on-interposer structures known in the art.

In some embodiments, IC device assembly 2300 may include an IC package 2324 coupled to first face 2340 of circuit board 2302 by coupling components 2322. Coupling components 2322 may take the form of any of the embodiments discussed above with reference to coupling components 2316, and IC package 2324 may take the form of any of the embodiments discussed above with reference to IC package 2320.

In some embodiments, IC device assembly 2300 may include a package-on-package structure 2334 coupled to second face 2342 of circuit board 2302 by coupling components 2328. Package-on-package structure 2334 may include an IC package 2326 and an IC package 2332 coupled together by coupling components 2330 such that IC package 2326 is disposed between circuit board 2302 and IC package 2332. Coupling components 2328 and 2330 may take the form of any of the embodiments of coupling components 2316 discussed above, and IC packages 2326 and/or 2332 may take the form of any of the embodiments of IC package 2320 discussed above. Package-on-package structure 2334 may be configured in accordance with any of the package-on-package structures known in the art.

FIG. 10 is a block diagram of an example computing device 2400 that may include one or more components having one or more IC packages in accordance with any of the embodiments disclosed herein. For example, any suitable ones of the components of computing device 2400 may include a microelectronic assembly (e.g., 100) in accordance with any of the embodiments disclosed herein. In another example, any one or more of the components of computing device 2400 may include any embodiments of IC package 2200 (e.g., as shown in FIG. 8). In yet another example, any one or more of the components of computing device 2400 may include an IC device assembly 2300 (e.g., as shown in FIG. 9).

A number of components are illustrated in the figure as included in computing device 2400, but any one or more of these components may be omitted or duplicated, as suitable for the application. In some embodiments, some or all of the components included in computing device 2400 may be attached to one or more motherboards. In some embodiments, some or all of these components are fabricated onto a single SoC die.

Additionally, in various embodiments, computing device 2400 may not include one or more of the components illustrated in the figure, but computing device 2400 may include interface circuitry for coupling to the one or more components. For example, computing device 2400 may not include a display device 2406, but may include display device interface circuitry (e.g., a connector and driver circuitry) to which display device 2406 may be coupled. In another set of examples, computing device 2400 may not include an audio input device 2418 or an audio output device 2408, but may include audio input or output device interface circuitry (e.g., connectors and supporting circuitry) to which audio input device 2418 or audio output device 2408 may be coupled.

Computing device 2400 may include a processing device 2402 (e.g., one or more processing devices). As used herein, the term “processing device” or “processor” may refer to any device or portion of a device that processes electronic data from registers and/or memory to transform that electronic data into other electronic data that may be stored in registers and/or memory. Processing device 2402 may include one or more DSPs, ASICs, CPUs, GPUs, cryptoprocessors (specialized processors that execute cryptographic algorithms within hardware), server processors, or any other suitable processing devices. Computing device 2400 may include a memory 2404, which may itself include one or more memory devices such as volatile memory (e.g., dynamic random access memory (DRAM)), nonvolatile memory (e.g., read-only memory (ROM)), flash memory, solid-state memory, and/or a hard drive. In some embodiments, memory 2404 may include memory that shares a die with processing device 2402. This memory may be used as cache memory and may include embedded dynamic random access memory (eDRAM) or spin transfer torque magnetic random access memory (STT-MRAM).

In some embodiments, computing device 2400 may include a communication chip 2412 (e.g., one or more communication chips). For example, communication chip 2412 may be configured for managing wireless communications for the transfer of data to and from computing device 2400. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

Communication chip 2412 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), LTE project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication chip 2412 may operate in accordance with a Global System for Mobile Communication (GSM), General Packet Radio Service (GPRS), Universal Mobile Telecommunications System (UMTS), High-Speed Packet Access (HSPA), Evolved HSPA (E-HSPA), or LTE network. The communication chip 2412 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). Communication chip 2412 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. Communication chip 2412 may operate in accordance with other wireless protocols in other embodiments. Computing device 2400 may include an antenna 2422 to facilitate wireless communications and/or to receive other wireless communications (such as AM or FM radio transmissions).

In some embodiments, communication chip 2412 may manage wired communications, such as electrical, optical, or any other suitable communication protocols (e.g., the Ethernet). As noted above, communication chip 2412 may include multiple communication chips. For instance, a first communication chip 2412 may be dedicated to shorter-range wireless communications such as Wi-Fi or Bluetooth, and a second communication chip 2412 may be dedicated to longer-range wireless communications such as global positioning system (GPS), EDGE, GPRS, CDMA, WiMAX, LTE, EV-DO, or others. In some embodiments, a first communication chip 2412 may be dedicated to wireless communications, and a second communication chip 2412 may be dedicated to wired communications.

Computing device 2400 may include battery/power circuitry 2414. Battery/power circuitry 2414 may include one or more energy storage devices (e.g., batteries or capacitors) and/or circuitry for coupling components of computing device 2400 to an energy source separate from computing device 2400 (e.g., AC line power).

Computing device 2400 may include a display device 2406 (or corresponding interface circuitry, as discussed above). Display device 2406 may include any visual indicators, such as a heads-up display, a computer monitor, a projector, a touchscreen display, a liquid crystal display (LCD), a light-emitting diode display, or a flat panel display, for example.

Computing device 2400 may include audio output device 2408 (or corresponding interface circuitry, as discussed above). Audio output device 2408 may include any device that generates an audible indicator, such as speakers, headsets, or earbuds, for example.

Computing device 2400 may include audio input device 2418 (or corresponding interface circuitry, as discussed above). Audio input device 2418 may include any device that generates a signal representative of a sound, such as microphones, microphone arrays, or digital instruments (e.g., instruments having a musical instrument digital interface (MIDI) output).

Computing device 2400 may include a GPS device 2416 (or corresponding interface circuitry, as discussed above). GPS device 2416 may be in communication with a satellite-based system and may receive a location of computing device 2400, as known in the art.

Computing device 2400 may include other output device 2410 (or corresponding interface circuitry, as discussed above). Examples of other output device 2410 may include an audio codec, a video codec, a printer, a wired or wireless transmitter for providing information to other devices, or an additional storage device.

Computing device 2400 may include other input device 2420 (or corresponding interface circuitry, as discussed above). Examples of other input device 2420 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

Computing device 2400 may have any desired form factor, such as a handheld or mobile computing device (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computing device, a server or other networked computing component, a printer, a scanner, a monitor, a set-top box, an entertainment control unit, a vehicle control unit, a digital camera, a digital video recorder, or a wearable computing device. In some embodiments, computing device 2400 may be any other electronic device that processes data.

The above description of illustrated implementations of the disclosure, including what is described in the abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize.

Example 1 is an apparatus, including a substrate having a surface with an edge, wherein the substrate includes a dielectric material with conductive pathways; a photonic integrated circuit (PIC) having a first surface and an opposing second surface, and including a first portion within a footprint of the substrate and a second portion that extends beyond the edge of the substrate, wherein the first surface of the first portion of the PIC is electrically coupled to one or more of the conductive pathways in the substrate; and a material on the second surface of the second portion of the PIC adjacent to the edge of the substrate, wherein the material includes a low modulus, elastic polymer composite.

Example 2 may include the subject matter of Example 1, and may further specify that the material includes silicone or other rubber.

Example 3 may include the subject matter of Example 1 or 2, and may further specify that the material has a thickness between 30 microns and 50 microns.

Example 4 may include the subject matter of any of Examples 1-3, and may further specify that the material has a width between 200 microns and 500 microns.

Example 5 may include the subject matter of any of Examples 1-4, and may further specify that the material includes a filler or an additive.

Example 6 may include the subject matter of Example 5, and may further specify that the filler includes aluminum and oxygen, zinc and oxygen, or silicon and oxygen.

Example 7 may include the subject matter of any of Examples 1-6, and may further specify that the material extends on to the surface of the substrate.

Example 8 may include the subject matter of any of Examples 1-7, and may further include a processor integrated circuit (XPU) at the surface of the substrate and electrically coupled to one or more of the conductive pathways in the substrate; and a die at least partially nested in the dielectric material of the substrate, wherein the die is electrically coupled to the PIC and the XPU.

Example 9 may include the subject matter of Example 8, and may further specify that the die is an electrical integrated circuit (EIC).

Example 10 may include the subject matter of Example 8, and may further specify that the die is a bridge die.

Example 11 may include the subject matter of any of Examples 1-10, and may further specify that the material is a first material, and the apparatus may further include a second material on the second surface of the second portion of the PIC, wherein the second material includes a thermal interface material (TIM), and wherein the first material is between the second material and the edge of the substrate.

Example 12 may include the subject matter of Example 11, and may further include a heat transfer structure at the second surface of the PIC, wherein the first material and the second material are between the PIC and the heat transfer structure.

Example 13 may include the subject matter of Example 12, and may further specify that the heat transfer structure is an integrated heat spreader (IHS).

Example 14 may include the subject matter of any of Examples 1-13, and may further specify that the PIC is a first PIC and the first surface of the second portion of the first PIC further includes a first fiber alignment region, and the apparatus may further include a second PIC adjacent to the first PIC, wherein the second PIC includes a first portion within the footprint of the substrate and a second portion that extends beyond the edge of the substrate, wherein the first surface of the first portion of the second PIC is electrically coupled to one or more of the conductive pathways in the substrate, and the first surface of the second portion of the second PIC includes a second fiber alignment region, and wherein the material is on the second surface of the second portion of the second PIC adjacent to the edge of the substrate.

Example 15 may include the subject matter of Example 14, and may further specify that the first and second fiber alignment regions include a V-shaped groove.

Example 16 is a photonic assembly, including a substrate having a surface with an edge, wherein the substrate includes a dielectric material with conductive pathways; a photonic integrated circuit (PIC) having a first surface and an opposing second surface, and including a first portion within a footprint of the substrate and a second portion that extends beyond the edge of the substrate, wherein the first surface of the first portion of the PIC is electrically coupled to one or more of the conductive pathways in the substrate; a heat transfer structure at the second surface of the PIC; a first material on the second surface of the second portion of the PIC adjacent to the edge of the substrate, wherein the first material includes a low modulus, elastic polymer composite, an adhesive tape, or a foam tape; and a second material on the second surface of the second portion of the PIC, wherein the second material includes a thermal interface material (TIM), wherein the first material is between the second material and the edge of the substrate, and wherein the first material and the second material are between the PIC and the heat transfer structure.

Example 17 may include the subject matter of Example 16, and may further specify that the first material has a thickness between 30 microns and 50 microns.

Example 18 may include the subject matter of Example 16 or 17, and may further specify that the first material has a width between 1 millimeter and 3 millimeters.

Example 19 may include the subject matter of any of Examples 16-18, and may further specify that the first material includes silicone or other rubber.

Example 20 may include the subject matter of any of Examples 16-19, and may further specify that the first material includes the low modulus, elastic polymer composite and further includes a filler or an additive.

Example 21 may include the subject matter of Example 20, and may further specify that the filler includes aluminum and oxygen, zinc and oxygen, or silicon and oxygen.

Example 22 may include the subject matter of any of Examples 16-21, and may further specify that the heat transfer structure is an integrated heat spreader (IHS).

Example 23 may include the subject matter of any of Examples 16-22, and may further specify that the first material extends on to the surface of the substrate.

Example 24 may include the subject matter of any of Examples 16-23, and may further include a processor integrated circuit (XPU) at the surface of the substrate and electrically coupled to one or more of the conductive pathways in the substrate; and a die at the surface of the substrate and electrically coupled to one or more of the conductive pathways in the substrate.

Example 25 may include the subject matter of Example 24, and may further specify that the XPU includes a Field-Programmable Gate Array (FPGA).

Example 26 may include the subject matter of Example 24, and may further specify that the die includes a transceiver die, a digital to analog converter die, an I/O die, a Platform Controller Hub (PCH), a memory die, or a high bandwidth memory (HBM) die.

Example 27 may include the subject matter of any of Examples 16-26, and may further specify that the PIC is a first PIC and the first surface of the second portion of the first PIC further includes a first fiber alignment region, and the photonic assembly may further include a second PIC adjacent to the first PIC, wherein the second PIC includes a first portion within the footprint of the substrate and a second portion that extends beyond the edge of the substrate, wherein the first surface of the first portion of the second PIC is electrically coupled to one or more of the conductive pathways in the substrate, and the first surface of the second portion of the second PIC includes a second fiber alignment region, and wherein the first material and the second material are on the second surface of the second portion of the second PIC and the first material is between the second material and the edge of the substrate.

Example 28 is a microelectronic assembly, including a substrate having a surface with an edge, wherein the substrate includes a dielectric material with conductive pathways; a first photonic integrated circuit (PIC) having a first surface and an opposing second surface, and including a first portion within a footprint of the substrate and a second portion that extends beyond the edge of the substrate, wherein the first surface of the first portion of the first PIC is electrically coupled to one or more of the conductive pathways in the substrate; a second PIC adjacent to the first PIC, wherein the second PIC includes a first portion within the footprint of the substrate and a second portion that extends beyond the edge of the substrate, and wherein the first surface of the first portion of the second PIC is electrically coupled to one or more of the conductive pathways in the substrate; a heat transfer structure at the second surface of the first PIC and the second PIC; a first material on the second surface of the second portion of the first PIC and the second PIC, wherein the first material is adjacent to the edge of the substrate, and wherein the first material includes a low modulus, elastic polymer composite, an adhesive tape, or a foam tape; and a second material on the second surface of the second portion of the first PIC and the second PIC, wherein the second material includes a thermal interface material (TIM), wherein the first material is between the second material and the edge of the substrate, and wherein the first material and the second material are between the first PIC and the heat transfer structure, and between the second PIC and the heat transfer structure.

Example 29 may include the subject matter of Example 28, and may further specify that the first material includes silicone or other rubber.

Example 30 may include the subject matter of Example 28 or 29, and may further specify that the first material has a thickness between 30 microns and 50 microns.

Example 31A may include the subject matter of any of Examples 28-30, and may further specify that the first material includes the low modulus, elastic polymer composite having a width between 200 microns and 500 microns.

Example 31B may include the subject matter of any of Examples 28-30, and may further specify that the first material has a width between 1 millimeter and 3 millimeters.

Example 32 may include the subject matter of any of Examples 28-31, and may further specify that the first material extends on to the surface of the substrate.

Example 33 may include the subject matter of any of Examples 28-32, and may further include a processor integrated circuit (XPU) at the surface of the substrate and electrically coupled to one or more of the conductive pathways in the substrate; and a die at least partially nested in the dielectric material of the substrate, wherein the die is electrically coupled to the first PIC and the XPU.

Example 34 may include the subject matter of Example 33, and may further specify that the die is an electrical integrated circuit (EIC).

Example 35 may include the subject matter of Example 33, and may further specify that the die is a bridge die.

Example 36 may include the subject matter of any of Examples 28-35, and may further specify that the first surface of the second portion of the first PIC further includes a fiber alignment region.

Example 37 may include the subject matter of Example 36, and may further specify that the fiber alignment region includes a V-shaped groove.

Example 38 may include the subject matter of any of Examples 28-35, and may further specify that the first surface of the second portion of the second PIC further includes a fiber alignment region.

Example 39 may include the subject matter of Example 38, and may further specify that the fiber alignment region includes a V-shaped groove.

Example 40 may include the subject matter of any of Examples 28-39, and may further specify that the heat transfer structure is an integrated heat spreader (IHS).

1. An apparatus, comprising:
a substrate having a surface with an edge, wherein the substrate includes a dielectric material with conductive pathways;
a photonic integrated circuit (PIC) having a first surface and an opposing second surface, and including a first portion within a footprint of the substrate and a second portion that extends beyond the edge of the substrate, wherein the first surface of the first portion of the PIC is electrically coupled to one or more of the conductive pathways in the substrate; and
a material on the second surface of the second portion of the PIC adjacent to the edge of the substrate, wherein the material comprises a low modulus, elastic polymer composite.

2. The apparatus of claim 1, wherein the material includes silicone or other rubber.

3. The apparatus of claim 1, wherein the material has a thickness between 30 microns and 50 microns.

4. The apparatus of claim 1, wherein the material has a width between 200 microns and 500 microns.

5. The apparatus of claim 1, wherein the material extends on to the surface of the substrate.

6. The apparatus of claim 1, wherein the material is a first material, and the apparatus further comprising:
a second material on the second surface of the second portion of the PIC, wherein the second material includes a thermal interface material (TIM), and wherein the first material is between the second material and the edge of the substrate.

7. The apparatus of claim 1, further comprising:
a heat transfer structure at the second surface of the PIC, wherein the material is between the PIC and the heat transfer structure.

8. The apparatus of claim 1, wherein the PIC is a first PIC and the first surface of the second portion of the first PIC further comprises a first fiber alignment region, and the apparatus further comprising:
a second PIC adjacent to the first PIC, wherein the second PIC includes a first portion within the footprint of the substrate and a second portion that extends beyond the edge of the substrate, wherein the first surface of the first portion of the second PIC is electrically coupled to one or more of the conductive pathways in the substrate, and the first surface of the second portion of the second PIC includes a second fiber alignment region, and wherein the material is on the second surface of the second portion of the second PIC adjacent to the edge of the substrate.

9. A photonic assembly, comprising:
a substrate having a surface with an edge, wherein the substrate includes a dielectric material with conductive pathways;
a photonic integrated circuit (PIC) having a first surface and an opposing second surface, and including a first portion within a footprint of the substrate and a second portion that extends beyond the edge of the substrate, wherein the first surface of the first portion of the PIC is electrically coupled to one or more of the conductive pathways in the substrate;
a heat transfer structure at the second surface of the PIC;
a first material on the second surface of the second portion of the PIC adjacent to the edge of the substrate, wherein the first material includes a low modulus, elastic polymer composite, an adhesive tape, or a foam tape; and
a second material on the second surface of the second portion of the PIC, wherein the second material includes a thermal interface material (TIM), wherein the first material is between the second material and the edge of the substrate, and wherein the first material and the second material are between the PIC and the heat transfer structure.

10. The photonic assembly of claim 9, wherein the first material has a thickness between 30 microns and 50 microns.

11. The photonic assembly of claim 9, wherein the first material has a width between 1 millimeter and 3 millimeters.

12. The photonic assembly of claim 9, wherein the first material extends on to the surface of the substrate.

13. The photonic assembly of claim 9, further comprising:
a processor integrated circuit (XPU) at the surface of the substrate and electrically coupled to one or more of the conductive pathways in the substrate; and
a die at the surface of the substrate and electrically coupled to one or more of the conductive pathways in the substrate.

14. The photonic assembly of claim 13, wherein the XPU includes a Field-Programmable Gate Array (FPGA).

15. The photonic assembly of claim 13, wherein the die includes a transceiver die, a digital to analog converter die, an I/O die, a Platform Controller Hub (PCH), a memory die, or a high bandwidth memory (HBM) die.

16. The photonic assembly of claim 9, wherein the PIC is a first PIC and the first surface of the second portion of the first PIC further comprises a first fiber alignment region, and the photonic assembly further comprising:
a second PIC adjacent to the first PIC, wherein the second PIC includes a first portion within the footprint of the substrate and a second portion that extends beyond the edge of the substrate, wherein the first surface of the first portion of the second PIC is electrically coupled to one or more of the conductive pathways in the substrate, and the first surface of the second portion of the second PIC includes a second fiber alignment region, and wherein the first material and the second material are on the second surface of the second portion of the second PIC and the first material is between the second material and the edge of the substrate.

17. A microelectronic assembly, comprising:
a substrate having a surface with an edge, wherein the substrate includes a dielectric material with conductive pathways;
a first photonic integrated circuit (PIC) having a first surface and an opposing second surface, and including a first portion within a footprint of the substrate and a second portion that extends beyond the edge of the substrate, wherein the first surface of the first portion of the first PIC is electrically coupled to one or more of the conductive pathways in the substrate;
a second PIC adjacent to the first PIC, wherein the second PIC includes a first portion within the footprint of the substrate and a second portion that extends beyond the edge of the substrate, and wherein the first surface of the first portion of the second PIC is electrically coupled to one or more of the conductive pathways in the substrate;
a heat transfer structure at the second surface of the first PIC and the second PIC;
a first material on the second surface of the second portion of the first PIC and the second PIC, wherein the first material is adjacent to the edge of the substrate, and wherein the first material includes a low modulus, elastic polymer composite, an adhesive tape, or a foam tape; and
a second material on the second surface of the second portion of the first PIC and the second PIC, wherein the second material includes a thermal interface material (TIM), wherein the first material is between the second material and the edge of the substrate, and wherein the first material and the second material are between the first PIC and the heat transfer structure, and between the second PIC and the heat transfer structure.

18. The microelectronic assembly of claim 17, wherein the first material has a thickness between 30 microns and 50 microns.

19. The microelectronic assembly of claim 17, wherein the first material extends on to the surface of the substrate.

20. The microelectronic assembly of claim 17, wherein the heat transfer structure is an integrated heat spreader (IHS).
